(19) United States
(12) Patent Application Publication
(10) Pub. No.: US 2026/0187266 A1
(43) Pub. Date: Jul. 2, 2026

(54) USING CROSS-INSTANCE PROFILE DATA FOR SELECTIVE CONTENT DELIVERY

(71) Applicant: Microsoft Technology Licensing, LLC, Redmond, WA (US)

(72) Inventors: Benny Jon Robaina, Seattle, WA (US); Jonathan Rochelle, Chester, NJ (US); Ajay Upadhyaya, San Ramon, CA (US); Sergio D. Burgos Cailloma, San Francisco, CA (US); Yarin M. Mera Colon, San Francisco, CA (US); Erica Kathryn Michel, New York, NY (US)

(21) Appl. No.: 19/212,299

(22) Filed: May 19, 2025

Related U.S. Application Data
(60) Provisional application No. 63/740,180, filed on Dec. 30, 2024.

(51) Int. Cl. G06F 21/62

(52) U.S. Cl. CPC G06F 21/6218

(57) ABSTRACT

An example verifies a relationship between an entity and a first group identifier. A first instance of a software application is established at a device. Use of the first instance is restricted to the entity having the verified relationship with the first group identifier. Via the first instance, verified profile data for the entity is stored. Access to the stored verified profile data is restricted to one or more entities that have a verified relationship with the first group identifier. Unverified profile data is provided to the first instance. The unverified profile data is obtained from use of a second instance of the software application. The first instance is to use the verified profile data and the unverified profile data to cause a content delivery event for the entity at the device via the first instance.

### CROSS-REFERENCE TO RELATED APPLICATIONS

The present application claims the benefit of and priority to U.S. Provisional Patent Application Ser. No. 63/740,180 filed Dec. 30, 2024, which is incorporated by reference herein.

### TECHNICAL FIELD

Technical fields to which this disclosure relates include digital content delivery systems.

### COPYRIGHT NOTICE

This patent document, including the accompanying drawings, contains material that is subject to copyright protection. The copyright owner has no objection to the facsimile reproduction of this patent document, as it appears in the publicly accessible records of the United States Patent and Trademark Office, consistent with the fair use principles of the United States copyright laws, but otherwise reserves all copyright rights whatsoever.

### BACKGROUND

A content delivery system is a computer system that is designed to deliver information, such as posts, articles, videos, images, recordings, web pages, user profiles, messages, notifications, recommendations, and job postings, to computing devices for perception (e.g., viewing, listening, etc.) and interaction by users of those devices. Examples of content delivery systems include digital content feeds, social media platforms, messaging systems, video sharing platforms, and search engines.

### BRIEF DESCRIPTION OF THE DRAWINGS

The disclosure will be understood more fully from the detailed description given below and from the accompanying drawings of various examples of the disclosure. The drawings are for explanation and understanding only and should not be taken to limit the disclosure to the specific examples shown.

FIG. 1 is a component-based flow diagram of an example method for using cross-instance profile data for selective content delivery in accordance with some examples of the present disclosure.

FIG. 2 is a component-based flow diagram of an example method for using cross-instance profile data for selective content delivery in accordance with some examples of the present disclosure.

FIG. 3 is a component-based flow diagram of an example method for using cross-instance profile data for selective content delivery in accordance with some examples of the present disclosure.

FIG. 4, FIG. 5, FIG. 6, FIG. 7, and FIG. 8 are screen captures of example user interface displays in accordance with some examples of the present disclosure.

FIG. 9 is a flow diagram of an example method for using cross-instance profile data for selective content delivery in accordance with some examples of the present disclosure.

FIG. 10 is a block diagram of a computing system that includes an instance manager system in accordance with some examples of the present disclosure.

FIG. 11A, FIG. 11B, FIG. 11C, FIG. 11D, and FIG. 11E are block diagrams of examples of machine learning models that are usable by and/or included in an instance manager system in accordance with some examples of the present disclosure.

FIG. 12 is an example of an entity graph in accordance with some embodiments of the present disclosure.

FIG. 13 is a block diagram of an example computer system including components of an instance manager system in accordance with some examples of the present disclosure.

### DETAILED DESCRIPTION

Users of content delivery services are often interested in tailoring their uses of those services to their various different life roles as they switch between those roles and as the roles change. For example, users of online job search services who are actively employed and not looking for a job often have different needs and preferences than users who are unemployed or searching for a new job. While many employers have programs aimed at connecting current employees with skill development and internal career growth opportunities, the systems supporting these company-sponsored initiatives are often fragmented, hard to find, cumbersome to use, or challenging to maintain.

Publicly available jobs platforms may be familiar to many users; more so than internal job boards. However, employed users may hesitate to use public platforms, even to look for career growth opportunities within their current company, due to the potential risk of negative inferences if their job searching activities are discovered by a broader audience. Further, purely public-facing platforms may not be well-suited for supporting internal company programs due to the potential risks of exposing internal information. While some public platforms allow users to individually restrict the visibility of portions of their profile information within the public-facing product, there is still a risk that sensitive information could be accessed by bad actors or unauthorized accounts.

Some jobs platforms suffer from data sparsity issues. Internal, e.g., company-specific, systems are more likely to contain more current and accurate information regarding certain aspects of employee profiles, organizational units, career trajectories, learning plans, promotion opportunities, etc. In contrast, public jobs platforms are more likely to contain more generalized profile data that is less specific to a particular company, less accurate, or less complete. However, public platforms often provide a broader spectrum of profile data across multiple different companies, industries, and geographic locations.

To address these and other issues, examples provide a group-specific instance of an application software system, in which entities that have a verified relationship with a group are able to create and maintain group-specific entity profiles, in addition to or as an alternative to public-facing entity profiles maintained in a public-facing instance of the system. The group-specific instance is restricted to use by entities that are verified members of the group for which the instance is created. Thus, a user associated with a group is able to maintain a public-facing profile in the public-facing instance, if desired, and a separate, group-specific profile in the group-specific instance of the application.

In some examples, the group-specific instance includes functionalities of an application software system that are tailored to group-specific requirements or goals. In some examples, a group-specific instance of a public jobs platform enables secure sharing of group-specific information, internal job postings, learning opportunities, and/or career guidance that are aligned with goals and requirements of the group, within the group-specific instance, and provides a clear separation between the group-specific instance and the publicly available instance.

In some examples, the group-specific instance is accessible via a profile switch mechanism and an entity verification service. The entity verification service ensures that entities accessing the group-specific instance are verified members of the group for which the group-specific instance is created.

In a content delivery service that selectively provides digital content to entity accounts, profile data is sometimes used to supplement received input with information about an entity that is the target of the content delivery service. Alternatively or in addition, profile data is sometimes used to determine an application state with respect to a target entity when the available input is absent or sparse. Examples of profile data include data that is directly or indirectly associated with an entity, such as attribute data listed on an entity profile page and interaction data evidencing explicit and/or implicit actions taken by the entity on the platform, such as content posts, views, likes, follows, shares, reactions, connections, etc.

To facilitate maintenance of group-specific entity profiles and public-facing entity profiles, and/or to improve content delivery services within the group-specific instance, examples provide a cross-instance data manager. The cross-instance data manager enables portions of public-facing or unverified profile data contained within a public-facing instance to be shared with the group-specific instance. In some examples, unverified profile data shared with the group-specific instance is used to supplement a verified entity profile page within the group-specific instance and/or to generate content delivery events (e.g., recommendations, search results, notifications, messages, etc.) within the group-specific instance, consistent with applicable data security policies, rules, and regulations. In some examples, verified profile data is sometimes selectively used to supplement an unverified entity profile page and/or to generate content delivery events (e.g., recommendations, search results, notifications, messages, etc.) within the unverified instance, consistent with applicable data security policies, rules, and regulations.

Entity as used herein refers to a person, object, or concept that has an associated identifier. In a software application, the identifier is often associated with a login account. Examples of entities include users, companies, organizations, institutions, associations, cohorts, or groups of entities. Other examples of entities include devices, networks, computer systems, hardware and/or software components, machine learning models, or agents. Still other examples of entities include physical devices such as sensors, robots, appliances, or vehicles. Aspects of any examples that are described referencing users are applicable to other types of entities in other examples.

Instance as used herein may refer to a specific occurrence, example, or representation of a software program or application system, such as a particular execution of a software program that has been or is capable of being loaded into memory. An instance may be implemented by a server computer running a software application. An instance may be implemented by a virtual machine that runs a software application in a cloud computing environment. An instance may also be referred to as an execution, or an execution unit, of a software application running on a physical or virtual machine. References to different instances of a software program or application mean that the same program or application has been loaded into memory multiple different times, with each instance corresponding to a different occurrence of the program or application being loaded into memory.

The disclosure will be understood more fully from the detailed description given below, which references the accompanying drawings. The detailed description of the drawings is for explanation and understanding, and should not be taken to limit the disclosure to the specific examples described. In some examples, components with the same name but different reference numbers in different figures have the same or similar functionality such that a description of one of those components with respect to one figure is applicable to other components with the same name in other drawings. Also, in the drawings and the following description, components shown and described in connection with some examples are capable of being used with or incorporated into other examples. In some examples, a component illustrated in a certain drawing is not limited to use in connection with the example to which the drawing pertains, but is usable with or incorporated into other examples, including examples shown in other drawings.

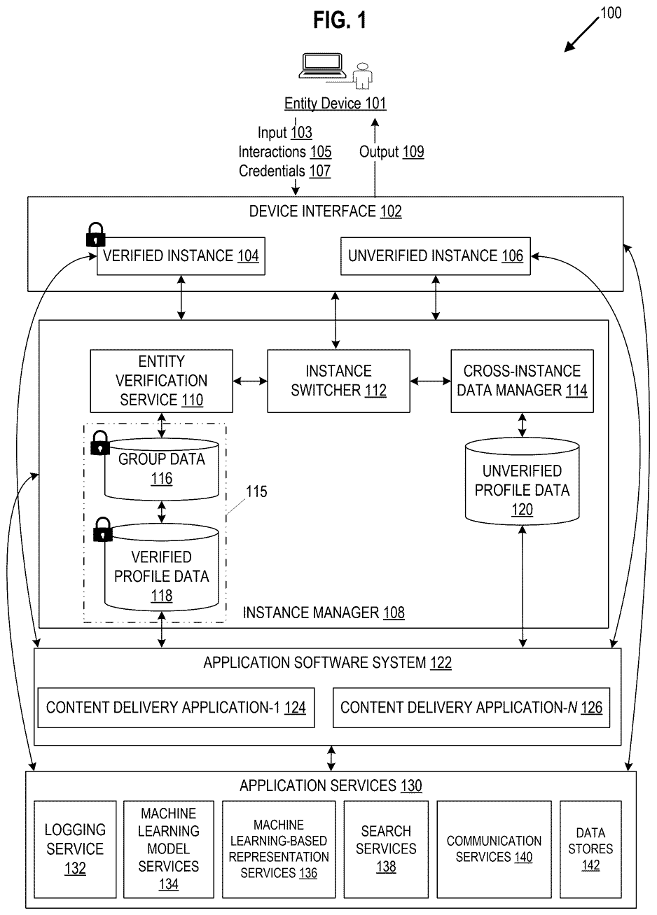

FIG. 1 is a component-based flow diagram of an example method for using cross-instance profile data for selective content delivery in accordance with some examples of the present disclosure.

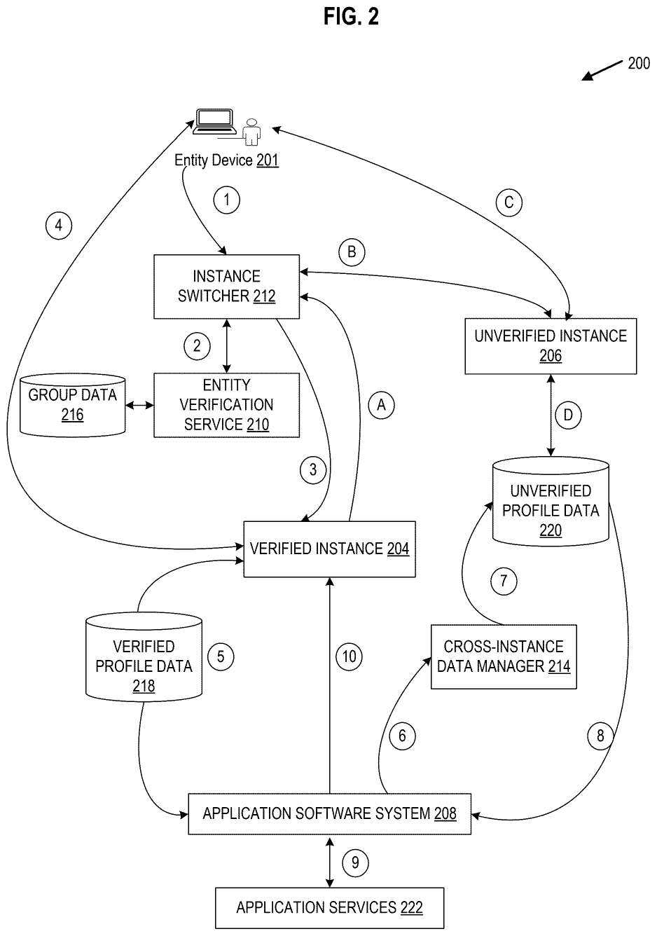

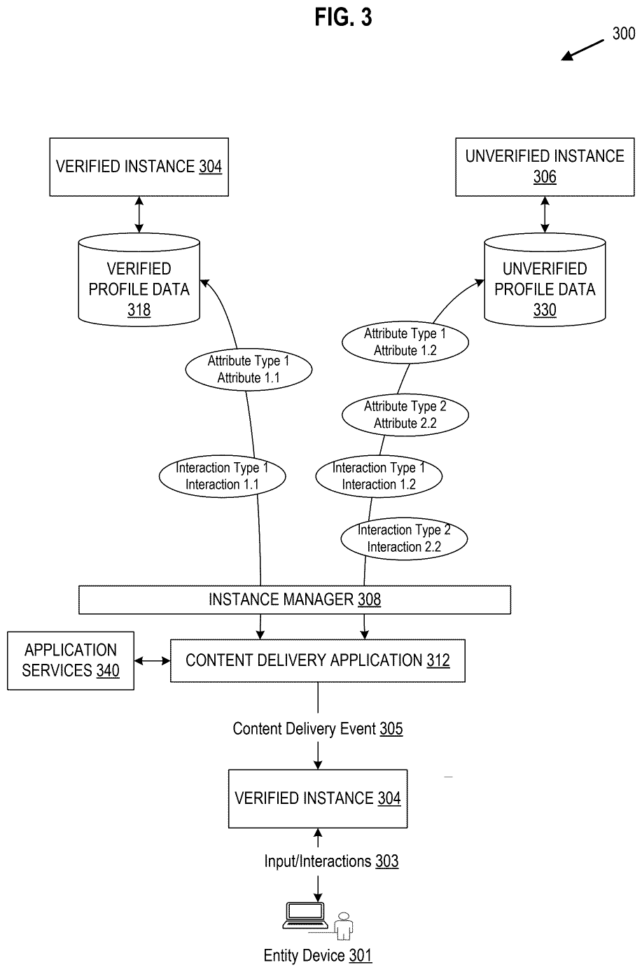

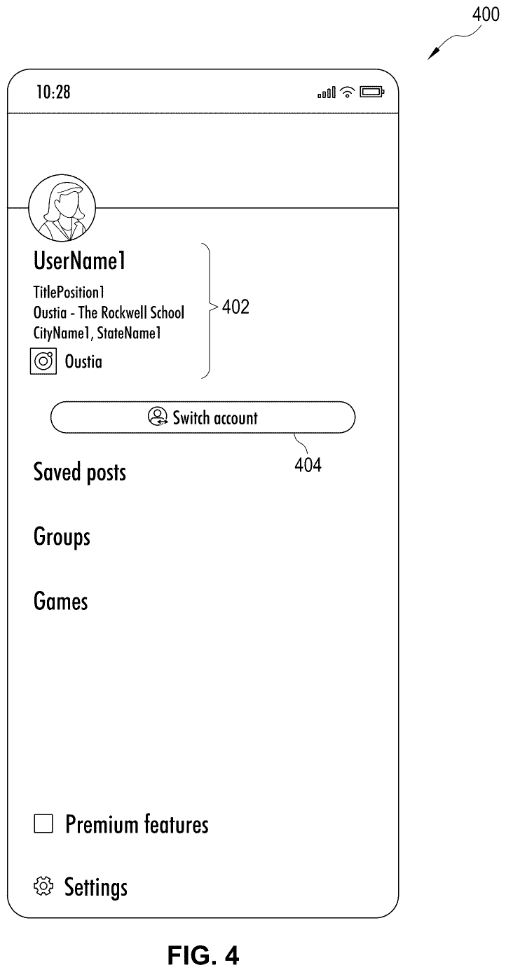

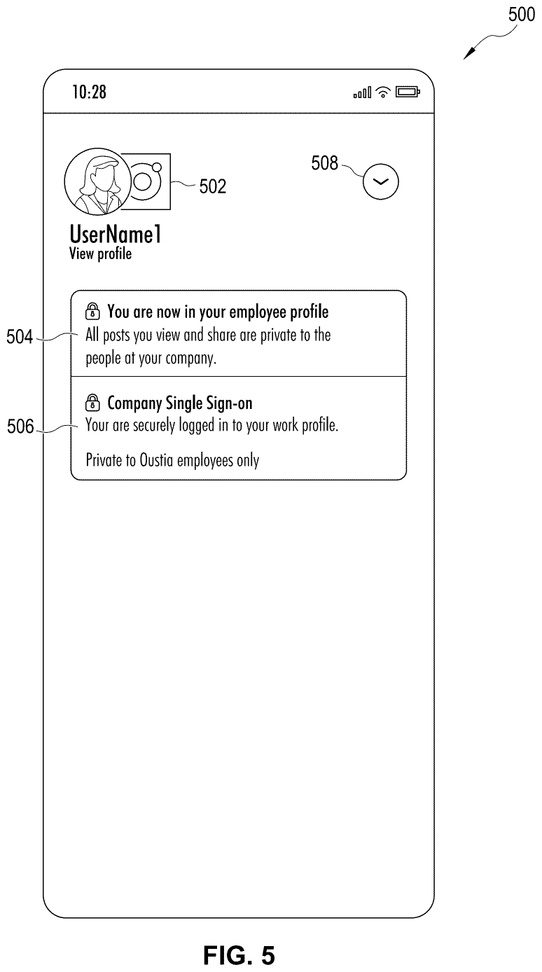

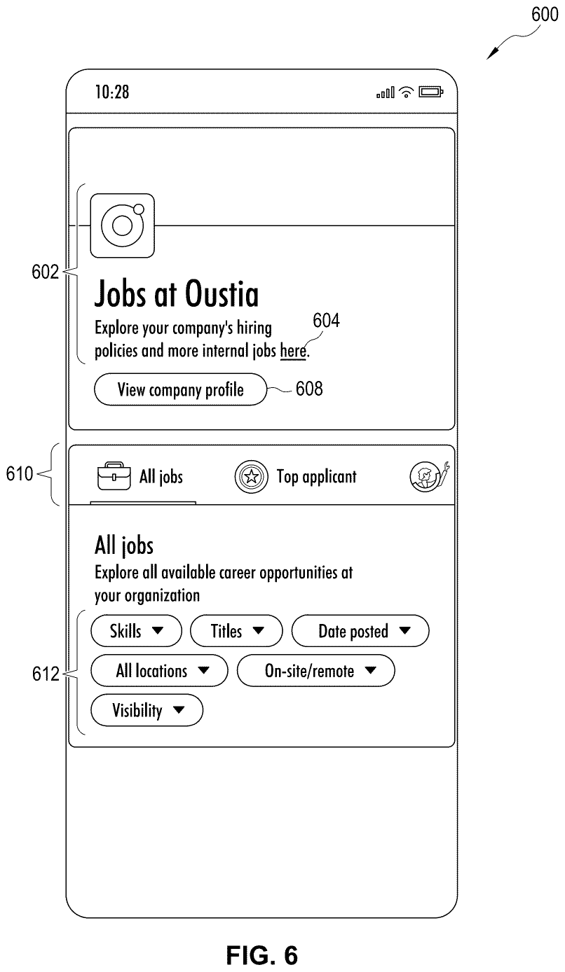

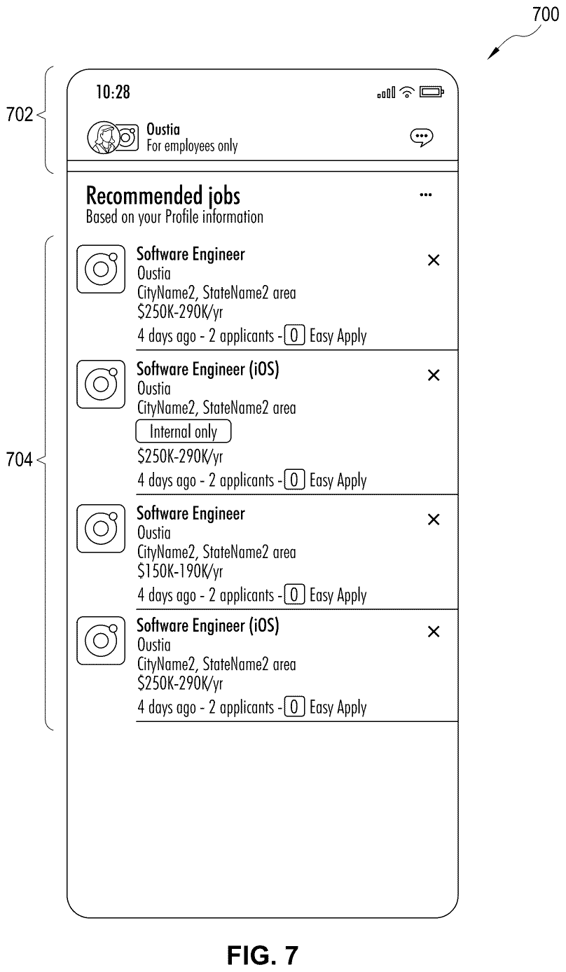

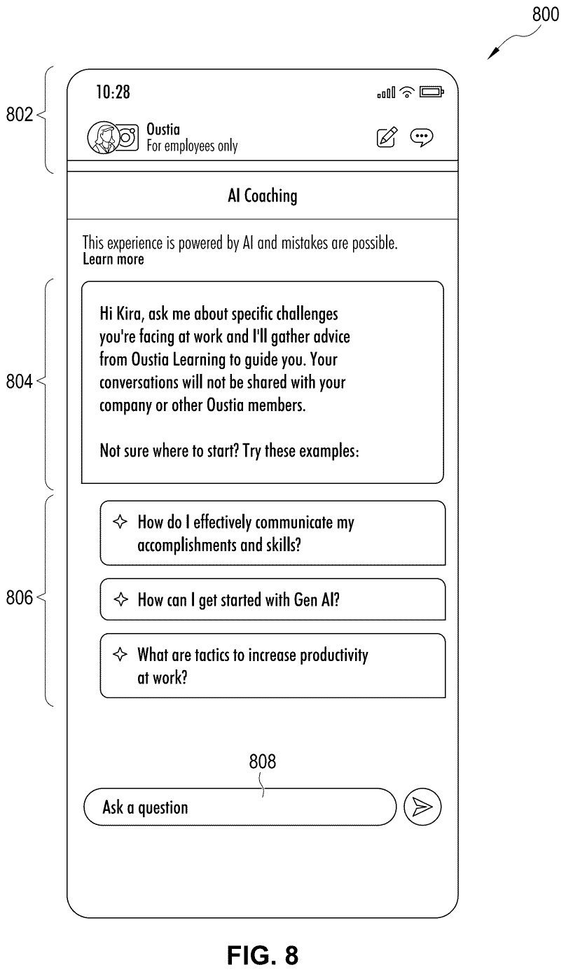

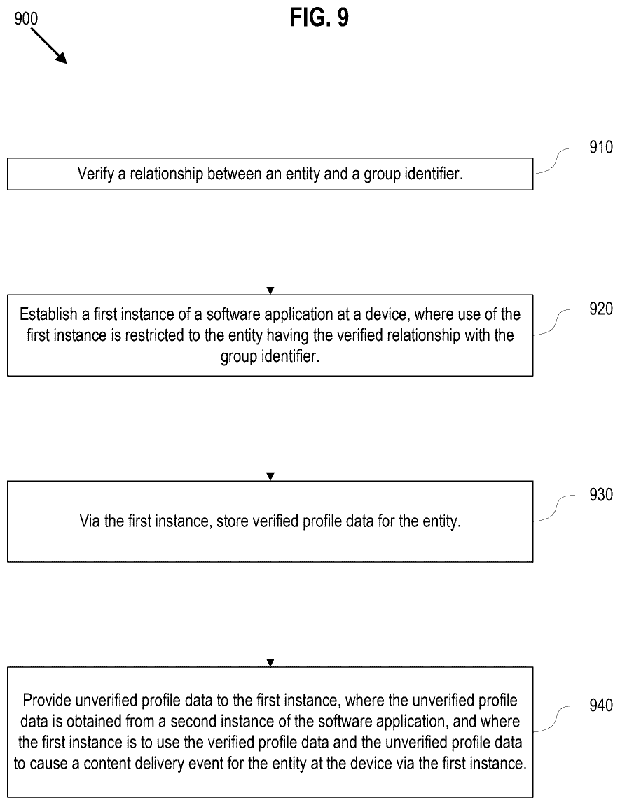

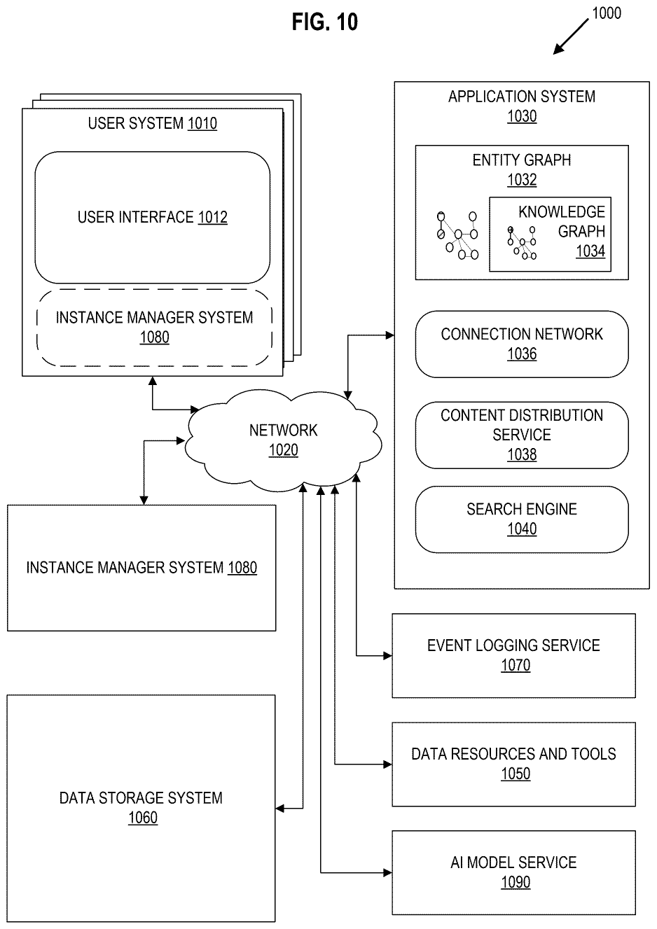

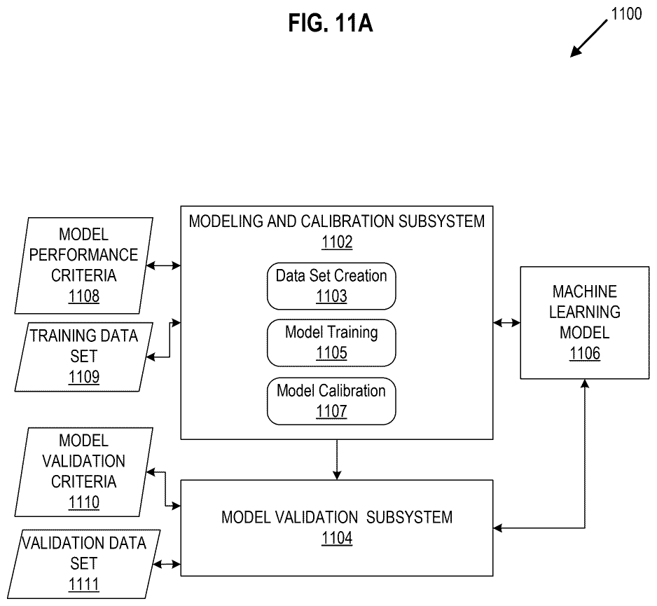

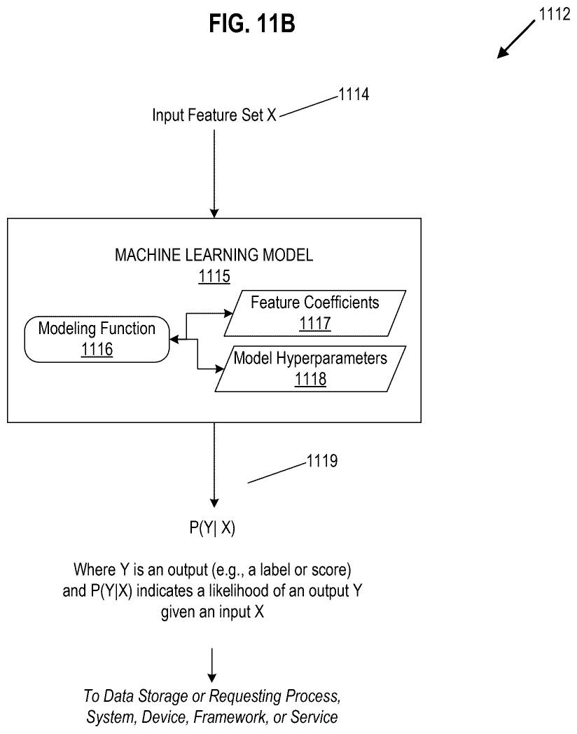

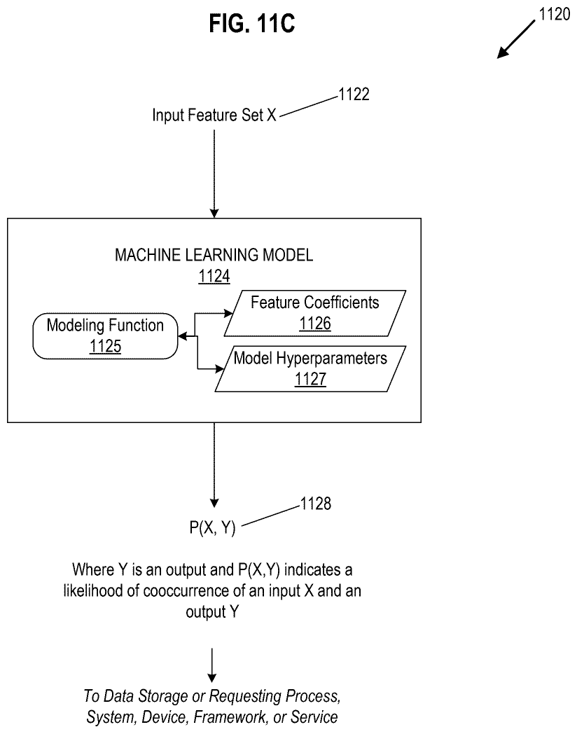

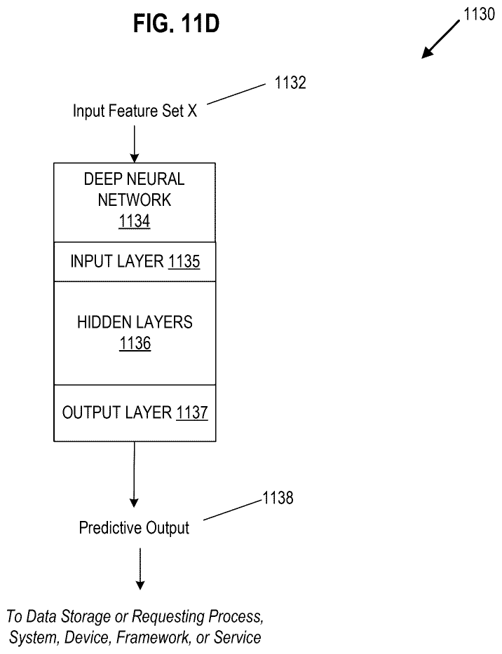

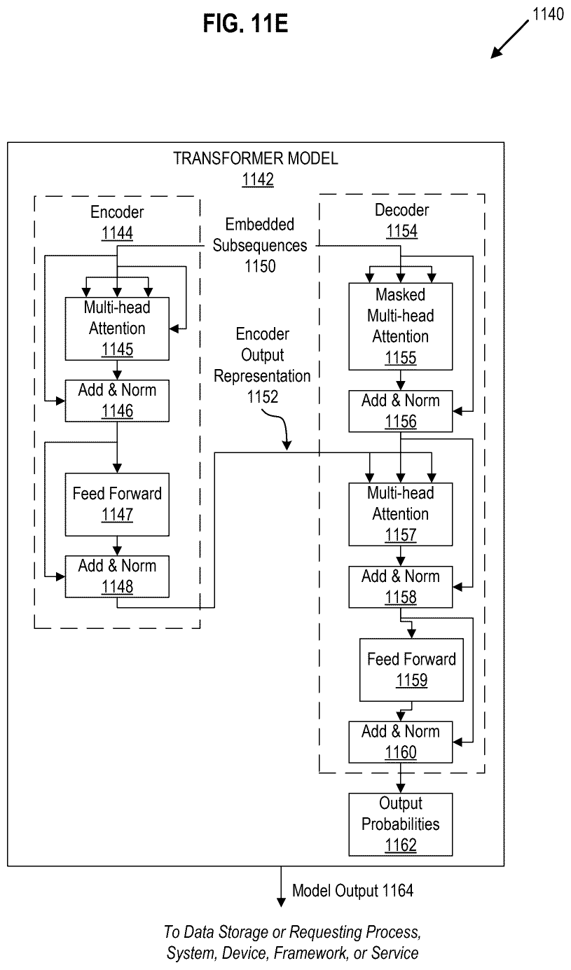

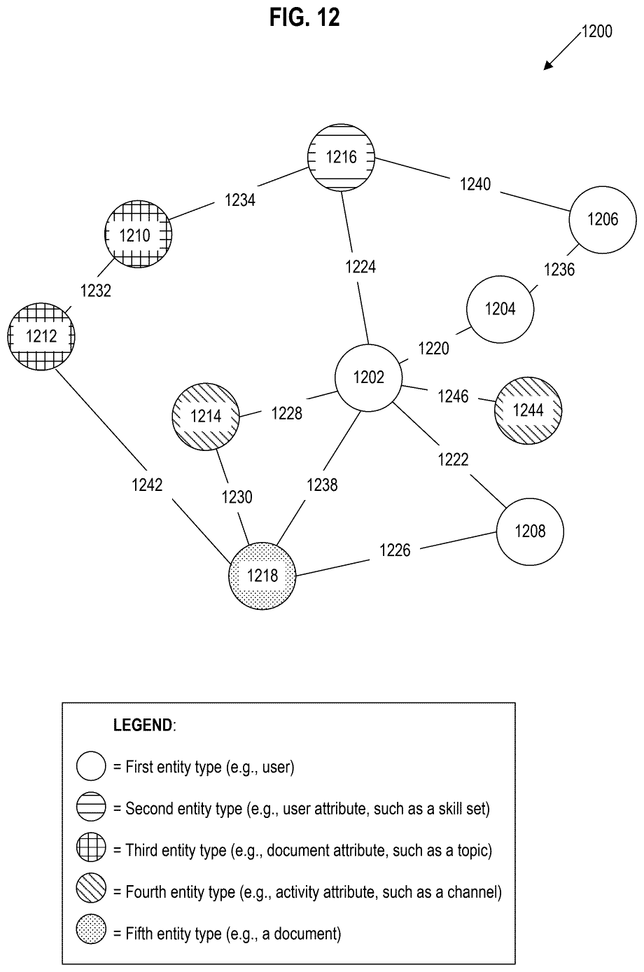

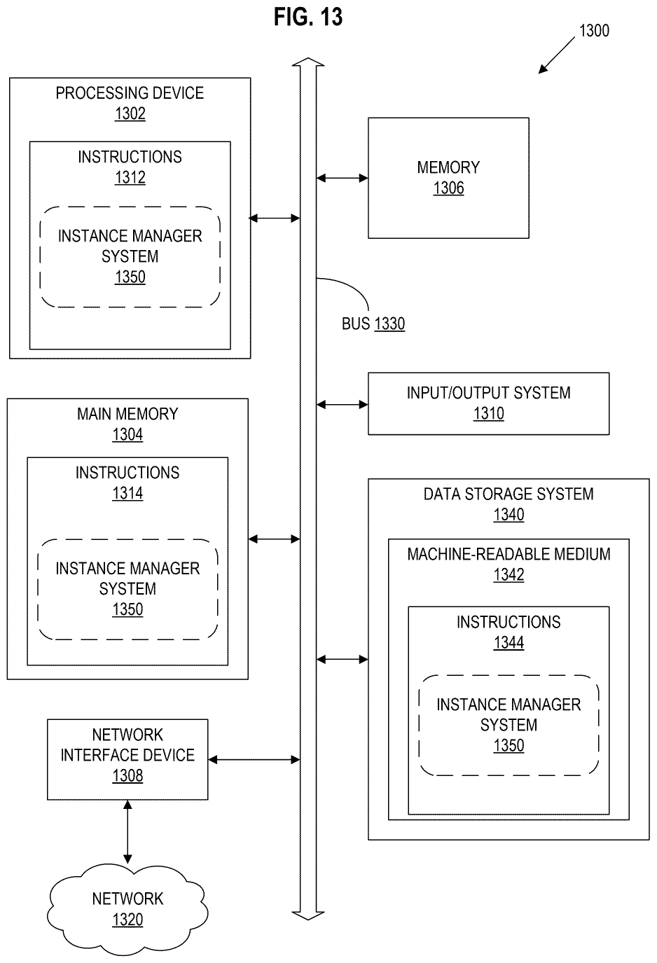

The method 100 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 100 is performed by the computing system components shown in FIG. 1. In other examples, portions of the method are performed by one or more of the computing system components shown in FIG. 2, FIG. 3, FIG. 4, FIG. 5, FIG. 6, FIG. 7, FIG. 8, FIG. 9, one or more components of computing system 1000 of FIG. 10, one or more machine learning models of FIG. 11A, FIG. 11B, FIG. 11C, FIG. 11D, or FIG. 11E, using an entity graph such as described with reference to FIG. 12, and/or one or more components of computing system 1300 of FIG. 13. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

In FIG. 1, the method 100 is represented by arrows connecting components of a computing system. The components of the computing system of FIG. 1 include an entity device 101, a device interface 102, an instance manager 108, an application software system 122, and application services 130. As described in more detail below, the instance manager 108 enables the entity device 101 to operate a verified instance 104 and/or an unverified instance 106 of the application software system 122. The instance manager enables selective sharing of unverified profile data 120 with the verified instance 104 for purposes of generating content delivery events in the verified instance 104 via one or more content delivery applications 124, 126 of the application software system 122.

The entity device 101 includes one or more electronic or electromechanical devices that communicate directly or indirectly with the device interface 102 in association with an entity, such as a user of the application software system 122. Examples of devices include computing devices, such as laptop computers, smart phones, mobile computing devices, smart appliances, wearable devices, game controls, vehicle controls, buttons, switches, robotic devices, electromechanical controls, and sensors.

The entity device 101 provides input 103, interactions 105, and/or credentials 107 to, and perceives output 109 generated by, the application software system 122, via the one or more associated devices. Examples of input 103 include entity profile data, such as attributes of an entity, e.g., descriptive information about the entity. In some examples, entity profile data includes attributes such as job title, job description, work history, education, and/or location. Examples of interactions 105 include digital interactions related to viewing, inputting, and/or updating entity profile data. Other examples of interactions 105 include digital interactions related to viewing, scrolling, reacting to, posting, or sharing, digital content, such as news items, articles, job postings, videos or audio streams, recordings, search results, and entity profiles. Examples of credentials include entity identifiers, group identifiers, and/or other information required to validate an entity as having a verified relationship with a group associated with a verified instance. Examples of output 109 include digital content and/or recommendations, notifications, search results, or messages relating to digital content items.

The device interface 102 includes an application layer, presentation layer, and/or data layer of application software system 122. The device interface 102 presents the instances 104, 106 via entity device 101. The device interface 102 manages and facilitates electronic and/or electromagnetic communications between the entity device 101 and the instances 104, 106 of the application software system 122.

The device interface 102 includes the verified instance 104 and/or the unverified instance 106. The verified instance 104 is group-specific in that the verified instance 104 is restricted to access and use by entities that have verified relationships with a group that is associated with the verified instance 104. An example of a group is a company, organization, institution, school, club, or cohort. An example of an association between a group and a verified instance is an arrangement by which the group provides its own data to populate the verified instance 104 in an exclusive or private arrangement with the application software system 122, such that the data accessible via the verified instance 104 is limited to the data provided or owned or approved by the group associated with the verified instance 104 and such data is inaccessible via the unverified instance 106. An example of a verified relationship with a group is a verified employer-employee relationship, where the relationship is verifiable by an entity verification service 110 of the instance manager 108.

The unverified instance 106 is accessible by entities associated with one or more different groups and entities not associated with any groups. In comparison to the verified instance 104, the unverified instance 106 is not restricted to access or use by entities that have a verified relationship with a specific group. In some examples, the unverified instance 106 is accessible via fewer or different credentials than are required for entities to access the verified instance 104. In some examples, the unverified instance 106 is a public- or consumer-facing version of the application software system 122 while the verified instance 104 is an enterprise- or company-specific version of the application software system 122.

The group data 116 and the verified profile data 118 are stored in a secure data store 115 that is inaccessible to the unverified instance 106. In some examples, the data 116, 118 are stored in a graph database and are retrievable for use in providing recommendations in the verified instance 104 but not in the unverified instance 106. In other examples, data is selectively shared between the verified and unverified instances to supplement one or the other, respectively, using, e.g., retrieval augmented generation (RAG) or similar techniques, in accordance with applicable policies, rules, and regulations for cross-instance data sharing. Separation of the secure data store 115 from the unverified instance 106 is accomplished using hardware and/or software data security method, such as physical separation on different devices or clusters, secure enclaves, and/or encryption techniques.

Access to and use of the verified instance 104 and the unverified instance 106 by the entity device 101 are controlled by the instance manager 108. The instance manager 108 includes entity verification service 110, instance switcher 112, cross-instance data manager 114, group data 116, verified profile data 118, and unverified profile data 120.

Entity verification service 110 communicates with instance switcher 112 and with group-specific data stores such as group data 116 and verified profile data 118, to control access by entity device 101 to the verified instance 104 and the data contained within the verified instance 104. Entity verification service 110 verifies credentials presented by the entity device 101 before enabling access to the verified instance 104 by the entity device 101.

In some examples, entity verification service 110 searches group data 116 to ensure that a credential presented by the entity device 101 matches information stored in the group data 116. The group data 116 includes group-specific data provided by the group that is associated with the verified instance 104, such as group-specific credentials, identifiers, login information, and/or access codes. Examples of an entity verification technique usable by entity verification service 110 to verify entity relationships with groups include single sign-on (SSO) mechanisms implemented with appropriate security measures such as passwords or passkeys and multi-factor authentication. An SSO is a session and user authentication tool or method that requires a user to present a specific set or sequence of login credentials that evidence permission to access a computer system before access to the computer system is granted.

The verified profile data 118 is associated with the group data 116 in that the verified profile data 118 is limited to storing entity profile data for entities that have verified relationships with the group that is associated with the verified instance 104, as indicated by the group data 116. Entity profile data for entities that do not have verified relationships with the group associated with the verified instance 104 is not stored in verified profile data 118.

If entity verification service 110 successfully determines via group data 116 that an entity has a verified relationship with the group associated with the verified instance 104, then profile data for that entity is stored in verified profile data 118. If entity verification service 110 does not successfully determine, via the group data 116, that an entity has a verified relationship with the group associated with the verified instance 104, then access to verified instance 104 by such entity is denied, access to unverified instance 106 is granted to that entity, and profile data for that entity is stored in unverified profile data 120 rather than in verified profile data 118.

The instance switcher 112 controls transitions between the verified instance 104 and the unverified instance 106, for a given entity device 101. If entity verification service 110 successfully determines that an entity requesting access to verified instance 104 from the unverified instance 106 has a verified relationship with the group associated with the verified instance 104, instance switcher 112 permits the entity to switch from the unverified instance 106 to the verified instance 104. If entity verification service 110 does not successfully determine that an entity requesting access to verified instance 104 from the unverified instance 106 has a verified relationship with the group associated with the verified instance 104, instance switcher 112 does not permit the entity to switch from the unverified instance 106 to the verified instance 104.

Instance switcher 112 permits verified entities that are also registered in the unverified instance 106 to switch from the verified instance 104 to the unverified instance 106, where registration in the unverified instance 106 entails a different level of security than the verified instance 104. In some examples, verification of an application login account enables the instance switcher 112 to permit an entity to access and use the unverified instance 106, while verification of one or more additional credentials, such as a group identifier and group-level authentication, is needed for the instance switcher 112 to permit access to the verified instance 104.

In some examples, instance switcher 112 does not enable any of the group data 116 or verified profile data 118 to be shared with the unverified instance 106. Whether and the extent to which instance switcher 112 enables sharing of verified profile data 118 with the unverified instance 106 is controlled by one or more group-specific policies applicable to the particular group and stored in group data 116. In some examples, portions of verified profile data 118 are not shared with the unverified instance 106 without explicit permission from the verified entity and/or the associated group.

In some examples, instance switcher 112 selectively enables portions of the unverified profile data 120 to be shared with the verified instance 104, for purposes of improving content delivery events such as recommendations, search results, notifications, or messages, in the verified instance 104, where such content deliver events are generated using one or more machine learning models, such as one or more generative machine learning models, e.g., large language models (LLMs). In some examples, instance switcher 112 does not enable any of the unverified profile data 120 to be shared with the verified instance 104 without explicit permission from the entity associated with the unverified profile data 120, as may be specified in one or more policies applicable to that entity.

Whether or not entity profile data is to be shared from unverified instance 106 to verified instance 104 or from verified instance 104 to unverified instance 106 is controlled by cross-instance data manager 114 in communication with entity verification service 110 via instance switcher 112. Cross-instance data manager 114 selectively provides unverified profile data 120 to verified instance 104 in response to requests from content delivery applications 124, 126, operating in the verified instance 104, in accordance with applicable policies. Cross-instance data manager 114 does not provide verified profile data 118 to unverified instance 106 unless entity and group approval is obtained in accordance with applicable policies. The applicable policies for sharing verified profile data 118 with unverified instance 106 are stored in group data 116 and/or verified profile data 118, in some examples. The applicable policies for sharing unverified profile data 120 with verified instance 104 are stored in unverified profile data 120, in some examples.

Application software system 122 includes N sub-applications, where Nis a positive integer. In the example of FIG. 1, the N sub-application s include content delivery application-1 124 and content delivery application-N 126. An example of an application software system 122 having multiple sub-applications is application system 1030 described with reference to FIG. 10. Examples of content delivery applications 124, 126 are connection network 1036, content distribution service 1038, and search engine 1040, described with reference to FIG. 10.

In some examples, one or more of content delivery applications 124, 126 are operated by artificial intelligence (AI) agents supported by machine learning model services 134 and/or machine learning-based representation services 136. In some examples, application software system 122 including content delivery applications 124, 126 is implemented as a multi-agent system in which the content delivery applications 124, 126 are operated by AI agents that communicate with each other via communication services 140.

Agent refers to a semi-autonomous or autonomous software system that is able to consume information and/or signals from its environment, execute logic, reasoning, and learning processes, and perform actions to achieve a specific goal or set of goals with minimal human guidance or intervention. In some examples, agents have multiple levels of autonomy. Some agents have the capacity to perform tasks requiring complex understanding, reasoning, learning, and adaptability. Some agents are capable of processing and interpreting natural language and/or multimodal digital content, determining relevant context, formulating plans, and learning from interactions or data inputs. Some agents dynamically adapt their processing capabilities in response to changing environments, inputs, or goals. Some agents are capable of interacting with human users and other systems, including other agents or groups of agents. Unlike simpler automated systems, agents are data-driven and are capable of utilizing machine learning and/or deep learning techniques to improve their performance over time, making them suitable for a wide range of search applications.

Application services 130 include software and/or hardware-based services that support one or more components of the application software system 122, instance manager 108, and device interface 102. The application services 130 are accessible to one or more components of the application software system 122, instance manager 108, and device interface 102 via queries, prompts, function calls, procedure calls, e.g., remote procedure calls, application programming interface (API) calls, inter-process communications, and/or other communication mechanisms.

The application services 130 includes a logging service 132, machine learning model services 134, machine learning-based representation services 136, search services 138, communication services 140, and data stores 142.

The logging service 132 logs events involving one or more of the entity device 101, device interface 102, instance manager 108, application software system 122, and/or application services 130, such as input 103, interactions 105, output 109, procedure calls, API calls, and/or other communications. In some examples, logging service 132 includes portions of event logging service 1070, described with reference to FIG. 10.

The machine learning model services 134 provide machine learning-based functionalities used by one or more of instance manager 108 and/or content delivery applications 124, 126 of application software system 122. In some examples, entity verification service 110 uses machine learning model services 134 to match entities with group data 116 and/or to classify input 103 and/or interactions 105. In some examples, cross-instance data manager 114 uses machine learning model services 134 to select portions of unverified profile data 120 to be shared with verified instance 104, e.g., by matching input 103 with portions of unverified profile data 120. In some examples, one or more of content delivery applications 124, 126 use machine learning model services 134 to match input 103 and/or interactions 105 with digital content, filter digital content, generate output 109, and/or to perform other tasks.

The machine learning model services 134 includes one or more machine learning models and related services, such as model training, validation, and serving platforms. The machine learning model services 134 include one or more generative machine learning models (GMLMs) and/or other types of machine learning models, such as discriminative models formulated for input and/or interaction classification. In some examples, machine learning model services 134 include portions of AI model service 1090, described with reference to FIG. 10. Examples of machine learning models that are capable of being supported by machine learning model services 134 are described with reference to FIG. 11A, FIG. 11B, FIG. 11C, FIG. 11D, and FIG. 11E.

The machine learning-based representation services 136 provide one or more functionalities that are used by one or more of instance manager 108 and/or content delivery applications 124, 126 of application software system 122. In some examples, cross-instance data manager 114 uses machine learning-based representation services 136 to generate machine learning-based representations of input 103 and/or interactions 105, which machine learning-based representation services 136 uses as input to embedding-based retrieval or semantic search services. In some examples, entity verification service 110 uses machine learning-based representation services 136 to generate machine learning-based representations of credentials 107 and/or group data 116, which machine learning-based representation services 136 uses as input to embedding-based retrieval services for purposes of validating entity relationships with groups. In some examples, one or more of content delivery applications 124, 126 use machine learning-based representation services 136 to match input 103 and/or interactions 105 with digital content and/or generate output 109 via e.g., retrieval augmented generation and/or retrieval-augmented reasoning techniques.

The machine learning-based representation services 136 include services that enable searching and matching using machine learning-based representations, such as vectors and embeddings. Machine learning-based representation services 136 include one or more representation models, e.g., embedding generators. Representation models receive variable length input and output a fixed length representation of the information contained in the variable length input, in accordance with the training data used to train the representation models. Examples of representation models include language models, large language models, generative machine learning models, and multi-modal generative machine learning models. The machine learning-based representation services 136 also include services that use machine learning-based representations to perform searching or matching tasks, such as embedding-based retrieval, semantic search, and/or retrieval augmented generation.

The search services 138 provide one or more functionalities that are used by one or more of instance manager 108 or content delivery applications 124, 126 of application software system 122 to retrieve or filter information using, e.g., a query language or graph query. In some examples, cross-instance data manager 114 uses search services 138 to retrieve or filter portions of unverified profile data 120 for sharing with verified instance 104. In some examples, entity verification services 110 uses search services 138 to retrieve or filter group data 116 or verified profile data 118. In some examples, one or more of content delivery applications 124, 126 use search services 138 to retrieve or filter digital content, such as portions of output 109. In some examples, search services 138 include portions of search engine 1040 described with reference to FIG. 10, including portions of search engine 1040 that are capable of traversing or retrieving and filtering information from graphs such as entity graph 1032 and/or knowledge graph 1034.

The communication services 140 provide synchronous and asynchronous communications capabilities that support communications between instance manager 108, device interface 102, application software system 122, and/or application services 130. In some examples, the communication services 140 support a large (e.g., millions or hundreds of millions) base of user accounts on a global online platform. In some examples, portions of communication services 140 support inter-agent communications, such as communications between different agents associated with different content delivery applications 124, 126 of application software system 122.

The data stores 142 are capable of storing information and content used by the device interface 102, instance manager 108, application software system 122, and/or application services 130. In some examples, data stores 142 store historical input 103 and/or interactions 105 collected over one or more time intervals. The historical data stored in data stores 142 includes entity-specific historical data and/or aggregate, anonymized, cross-entity historical data such as aggregations, e.g., counts, averages, maximum and minimum values, and/or other statistics.

In operation, an entity device 101 provides input 103, interactions 105, and/or credentials 107 to device interface 102. Device interface 102 provides credentials 107 to instance switcher 112. Instance switcher 112 provides credentials 107 to entity verification service 110. Entity verification service 110 determines whether the credentials 107 have a verified relationship with a group associated with a verified instance 104. Entity verification service 110 returns a signal to instance switcher 112.

In response to the signal from entity verification service 110, instance switcher 112 determines whether to load verified instance 104 or unverified instance 106. Instance switcher 112 loads verified instance 104 in response to validating credentials 107 as having a verified relationship with the group associated with the verified instance 104. If instance switcher 112 is unable to validate credentials 107 as having a verified relationship with the group associated with the verified instance 104, instance switcher 112 loads unverified instance 106.

While device interface 102 is operating in verified instance 104, e.g., during a login session associated with the group, input 103 and interactions 105 received via the verified instance 104 are stored in verified profile data 118. While device interface 102 is operating in unverified instance 106, e.g., during a login session not associated with the group, input 103 and interactions 105 received via the unverified instance 106 are stored in unverified profile data 120.

While device interface 102 is operating a content delivery application 124, 126 in verified instance 104, cross-instance data manager 114 selectively provides portions of unverified profile data 120 to the content delivery application 124, 126 operating in verified instance 104 for purposes of supplementing verified profile data 118 used to generate content delivery events. In some examples, cross-instance data manager 114 selects portions of unverified profile data 120 that match an input 103 and/or interaction 105 received in the verified instance 104, and provides those portions of the unverified profile data 120 to the content delivery application 124, 126 operating in the verified instance 104, to be used, e.g., as input to a machine learning model for purposes of generating recommendations, notifications, search results, messages, or other types of output 109.

In some examples, instance manager 108 operating in communication with verified instance 104, application software system 122, and application services 130 provides group-specific libraries of components that are customized according to the requirements of particular groups, such as group-specific aesthetics and group-branded widgets that are visually and functionally distinctive and representative of the group, when operating verified instance 104, such that these group-specific elements are not accessible to the unverified instance 106.

In some examples, instance switcher 112 executes group-specific workflows through which verified entities onboard into verified instance 104 and interact with portions of application software system 122 via verified instance 104, to ensure clear communication of the distinction between the verified instance 104 and the unverified instance 106 and also to ensure clear separation between verified profile data 118 and unverified profile data 120. Some group-specific workflows verify that only group-specific data is stored, presented, and shared via the verified instance 104 and that no group-specific data is stored, presented, or shared via the unverified instance 106.

In some examples, entity verification service 110 provides an alternative to public-facing verification processes. Whereas public-facing verification processes may require users to provide sensitive personal data to establish self-verification, entity verification service 110 instead provides entity validation by verifying a relationship with a group known to be associated with a verified instance 104; thereby potentially expediting verification of certain entity profiles.

The separation of the verified instance 104 from the unverified instance 106 enables the group associated with the verified instance 104 to tailor its users' experiences with the application software system 122 toward group-specific goals such as employee retention, education, upskilling, and internal career growth.

In some examples, instance manager 108 enables users of an unverified instance 106 who also have a verified relationship with a group associated with a verified instance 104 to, via entity verification service 110, seamlessly transition to the verified instance 104 using an SSO sign-in and/or an employment verification process through which additional layers of security are provided to protect group-internal information.

The examples shown in FIG. 1 and the accompanying description are provided for illustration purposes. This disclosure is not limited to the described examples.

FIG. 2 is a component-based flow diagram of an example method for using cross-instance profile data for selective content delivery in accordance with some examples of the present disclosure.

The method 200 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 200 is performed by the computing system components shown in FIG. 2. In other examples, portions of the method are performed by one or more of the computing system components shown in FIG. 1, FIG. 3, FIG. 4, FIG. 5, FIG. 6, FIG. 7, FIG. 8, FIG. 9, one or more components of computing system 1000 of FIG. 10, one or more machine learning models of FIG. 11A, FIG. 11B, FIG. 11C, FIG. 11D, or FIG. 11E, using an entity graph such as described with reference to FIG. 12, and/or one or more components of computing system 1300 of FIG. 13. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

In FIG. 2, the method 200 is represented by arrows connecting components of a computing system. The computing system includes an entity device 201, a verified instance 204, an unverified instance 206, an application software system 208, an entity verification service 210, an instance switcher 212, a cross-instance data manager 214, verified profile data 218, unverified profile data 220, and application services 222.

The descriptions of components shown in FIG. 1 having names similar to components shown in FIG. 2 are applicable to those corresponding components of FIG. 2, in some examples. Thus, entity device 201, verified instance 204, unverified instance 206, application software system 208, entity verification service 210, instance switcher 212, cross-instance data manager 214, verified profile data 218, unverified profile data 220, and application services 222 have similar functionalities as entity device 101, verified instance 104, unverified instance 106, application software system 122, entity verification service 110, instance switcher 112, cross-instance data manager 114, verified profile data 118, unverified profile data 120, and application services 130 of FIG. 1, in some examples. Verified instance 204 and unverified instance 206 are components of a device interface such as device interface 102, in some examples. Entity verification service 210, instance switcher 212, cross-instance data manager 214, verified profile data 218, and unverified profile data 220 are part of an instance manager such as instance manager 108, in some examples.

In the method 200, at (1), instance switcher 212 receives credentials from entity device 201. At (2), instance switcher 212 passes the credentials to entity verification service 210 and receives a signal from entity verification service 210 indicating that the credentials satisfy the requirements for establishing that the entity associated with the entity device 201 and the credentials has a verified relationship with a group associated with a verified instance 204. To generate the signals, entity verification service 210 queries group data 216 using the credentials.

In some examples, the credentials are established during a setup procedure so that once the setup process is complete, the entity device 201 does not need to be prompted for credentials to the instance switcher 212 to load the verified instance (e.g., the verified instance 204 is accessed via an existing portal, such as via an application programming interface). In some examples, the instance switcher 212 references the verified credentials previously obtained via the setup procedure in loading load the verified instance rather than explicitly prompting for and validating credentials at instance switching time.

At (3), instance switcher 212 loads verified instance 204 using the verified credentials. At (4), the verified entity engages in interactions with the application software system 208 via the verified instance 204 during use of the verified instance 204. At (5), verified profile data 218 associated with the verified entity is loaded into the verified instance 204 and used to operate the application software system 208 (e.g., to generate content delivery events) in the verified instance 204.

At (6), application software system 208 sends a data request for a portion of unverified profile data 220 to cross-instance data manager 214. In some examples, application software system 208 initiates the data request after analyzing performance metrics associated with content delivery events generated using verified profile data 218, alone. If a performance metric does not meet or exceed a performance threshold for a content delivery event generated using only verified profile data 218 (e.g., a click probability is below a minimum click probability), the application software system 208 requests a portion of unverified profile data 220 to supplement the verified profile data 218. In some examples, the performance evaluation is omitted such that the application software system 208 combines the verified and unverified profile data without first analyzing performance metrics.

At (7), cross-instance data manager 214 verifies the data request (e.g., determines that application software system 208 has permission to issue the data request) and formulates a query using the data request received at (6). Cross-instance data manager 214 queries unverified profile data 220 using the query formulated based on the data request. At (8), in response to the query, a portion of unverified profile data 220 responsive to the query is provided to application software system 208, in response to the data request initiated at (6).

At (9), application software system 208 provides both the verified profile data 218 and the portion of unverified profile data 220 received at (8) to application services 222. Application services uses the verified profile data 218 and the selectively retrieved portion of unverified profile data 220 to generate one or more content delivery events. At (10), one or more of the content delivery events generated by application services 222 and application software system 208 using the verified profile data 218 and the selectively retrieved portion of unverified profile data 220 are provided to verified instance 204 for presentation at the entity device 201.

In an alternative or additional portion of the method 200, which may occur prior to actions (6) through (10), for example, at (A), the verified instance 204 receives a request from entity device 201 to switch from the verified instance 204 to the unverified instance 206. The switch request is processed by instance switcher 212. At (B), instance switcher 212 at least temporarily closes or suspends verified instance 204 and loads unverified instance 206. At (C), the entity interacts with the application software system 208 via the entity device 201 and the unverified instance 206. During use of the unverified instance 206, input and/or interactions are stored in unverified profile data 220.

Thus, when cross-instance data manager 214 queries unverified profile data 220, e.g., at (7), the unverified profile data 220 includes input and/or interaction data resulting from the entity's use of the unverified instance 206 and added to the unverified profile data 220 up to the time of the query. In some examples, the entity's use of the unverified instance 206 (e.g., interaction data in the unverified instance) is used to supplement the unverified profile data 220. Alternatively or in addition, unverified profile data for other entities (e.g., other users of the unverified instance) are used to supplement the response or recommendation provided in a content delivery event for the entity.

The examples shown in FIG. 2 and the accompanying description are provided for illustration purposes. This disclosure is not limited to the described examples.

FIG. 3 is a component-based flow diagram of an example method for using cross-instance profile data for selective content delivery in accordance with some examples of the present disclosure.

The method 300 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, the method 300 is performed by the computing system components shown in FIG. 3. In other examples, portions of the method are performed by one or more of the computing system components shown in FIG. 1, FIG. 2, FIG. 4, FIG. 5, FIG. 6, FIG. 7, FIG. 8, FIG. 9, one or more components of computing system 1000 of FIG. 10, one or more machine learning models of FIG. 11A, FIG. 11B, FIG. 11C, FIG. 11D, or FIG. 11E, using an entity graph such as described with reference to FIG. 12, and/or one or more components of computing system 1300 of FIG. 13. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

In FIG. 3, the method 300 is represented by arrows connecting components of a computing system. The computing system includes an entity device 301, a verified instance 304, an unverified instance 306, an instance manager 308, a content delivery application 312, verified profile data 318, unverified profile data 330, and application services 340.

The descriptions of components shown in FIG. 1 or FIG. 2 having names similar to components shown in FIG. 3 are applicable to those corresponding components of FIG. 3, in some examples. Thus, entity device 301, verified instance 304, unverified instance 306, instance manager 308, content delivery application 312, verified profile data 318, unverified profile data 330, and application services 340 have similar functionalities as entity device 201, verified instance 204, unverified instance 206, instance manager 108, content delivery application 124, 126, verified profile data 218, unverified profile data 220, and application services 222 of FIG. 1 or FIG. 2, as the case may be, in some examples.

In the method 300, a user of entity device 301 is established as having a verified relationship with a group associated with the verified instance 304. The content delivery application 312 receives input and/or interactions 303 from the entity device 301 via verified instance 304. Because the content delivery application 312 is operating in the verified instance 304, instance manager 308 permits access to verified profile data 318 by content delivery application 312 in the verified instance 304. The verified profile data 318 is created as a result of historical use of the verified instance 304 by the user associated with the entity device 301 and/or other verified users of the verified instance 304. If the content delivery application 312 were operating in the unverified instance 306, the verified profile data 318 would be inaccessible to the content delivery application 312 through the unverified instance 306.

The instance manager 308 also permits the content delivery application 312 selective access to unverified profile data 330 when the content delivery application 312 is operating in the verified instance 304. The unverified profile data 330 is created as a result of historical use of the unverified instance 306 by the user associated with the entity device 301 and/or other users of the unverified instance 306.

The content delivery application 312 provides portions of verified profile data 318 and portions of unverified profile data 330 to application services 340 and receives output from the application services 340 (e.g., predictive output and/or digital content generated by machine learning model services 134), which content delivery application 312 uses to formulate a content delivery event 305. The content delivery application presents the content delivery event 305 to the entity at the entity device 301 via the verified instance 304.

FIG. 3 illustrates various different types of profile data that are sharable from verified profile data 318 to verified instance 304 and from unverified profile data 330 to verified instance 304. Each of verified profile data 318 and unverified profile data 330 include attribute types, such as canonical attribute names (e.g., field or object names, such as “job title,” “job description,” etc.). Verified profile data 318 also includes attribute data (or attribute values), which are associated with corresponding attribute types (e.g., “Software Engineer,” “Developing new applications using Java and/or Python”, etc.). Verified profile data 318 also includes interaction types, such as canonical interaction names (e.g., “view, follow, connect, like, etc.”), and associated interaction data (e.g., “0” for no or a negative interaction and “1” for a positive interaction).

FIG. 3 illustrates that portions of unverified profile data 330 that are shared with the verified instance 304 correspond to the same attribute types and interaction types as are contained in the verified profile data 318 and/or contain other attribute and interaction types that are different from or not present in the verified profile data 318. In the example of FIG. 3, both the verified profile data 318 and the unverified profile data 330 selected for use in generating the content delivery event 305 in the verified instance 304 include attribute type 1 and interaction type 1. However, the portion of unverified profile data 330 used to generate the content delivery event 305 in the verified instance 304 includes a different attribute value (Attribute 1.2) for Attribute Type 1. Also, or alternatively, the portion of unverified profile data 330 used to generate the content delivery event 305 in the verified instance 304 includes a different attribute type (Attribute Type 2) and corresponding attribute value (Attribute 2.2).

Alternatively or in addition, the portion of unverified profile data 330 used to generate the content delivery event 305 in the verified instance 304 includes a different interaction (Interaction 1.2) for the same interaction type (Interaction Type 1). Additionally or alternatively, the portion of unverified profile data 330 used to generate the content delivery event 305 in the verified instance 304 includes a different interaction type (Interaction Type 2) and corresponding interaction (Interaction 2.2).

FIG. 3 illustrates how instance manager 308 selectively provides portions of unverified profile data 330 to a content delivery application 312 for use in combination with verified profile data 318 to generate content delivery events 305 for a verified instance 304. In some examples, the verified profile data 318 contains group-specific job titles, acronyms, and jargons. The instance manager 308 enables the content delivery application 312 to train or fine tune a machine learning model to generate content delivery events (e.g., recommendations, notifications, search results, messages, etc.) based on group-specific attribute types, acronyms, and jargon. If the group-specific training data is sparse or the output of a machine learning model trained in this manner does not meet or exceed applicable performance criteria, instance manager 308 is capable of obtaining selected portions of unverified profile data 330 to supplement the group-specific training data to improve the machine learning model output and thereby improve the content delivery event 305.

The examples shown in FIG. 3 and the accompanying description are provided for illustration purposes. This disclosure is not limited to the described examples.

FIG. 4, FIG. 5, FIG. 6, FIG. 7, and FIG. 8 are screen captures of example user interface displays in accordance with some examples of the present disclosure.

FIG. 4, FIG. 5, FIG. 6, FIG. 7, and FIG. 8 illustrate examples of processes described herein, including example depictions of graphical user interface elements, in accordance with some examples of the present disclosure. The user interfaces shown in FIG. 4, FIG. 5, FIG. 6, FIG. 7, and FIG. 8 are presented by an instance of an application software system, in some examples.

In the user interface examples shown in FIG. 4, FIG. 5, FIG. 6, FIG. 7, and FIG. 8, certain data that would normally be displayed via the user interface is anonymized for the purpose of this disclosure. In a live example, the actual data and not the anonymized version of the data would be displayed. For instance, the text “CompanyName” would be replaced with a name of an actual company and “FirstName LastName” would be replaced with a user's actual name.

The user interface elements shown in FIG. 4, FIG. 5, FIG. 6, FIG. 7, and FIG. 8 are presented to a user via one or more devices, e.g., by an application system. In some examples, portions of the user interface elements are implemented as one or more web pages that are stored, e.g., at a user device, a server or in a cache of a user device, and then loaded into a display of a user device via the user device sending a page load request to the server or fetching data from the cache.

The graphical user interface control elements (e.g., fields, boxes, buttons, etc.) shown in the screen captures are implemented via software used to construct the user interface screens. While the screen captures illustrate examples of user interface components, e.g., visual displays, buttons, input boxes, etc., this disclosure is not limited to the illustrated examples, or to visual displays, or to graphical user interfaces.

In FIG. 4, a user interface 400 illustrates an example of a display screen that is capable of being presented to a user via, e.g., a user system. The user interface 400 presents an entity profile page for a user of an unverified instance, e.g., a public-facing or consumer version, of an online system. The entity profile page of user interface 400 includes unverified entity profile data 402. The unverified entity profile data 402 includes a user name (e.g., Cheri Sparks), attribute data such as job title (e.g., Staff Accountant), employer name (e.g., Oustia), education (e.g., The Rockwell School), and location (e.g., Cambridge, Massachusetts). The unverified entity profile data 402 includes other attributes or attribute data in other examples.

The entity profile page of user interface 400 includes a switch account mechanism 404, e.g., a selectable user interface element such as a graphical button. Selecting or otherwise activating the switch account mechanism 404 initiates an instance switching process, such as a process of switching from the unverified instance of FIG. 4 to a verified instance associated with a particular group as described with reference to instance switchers 112, 212. Switching from an unverified instance to a verified instance is a bound experience, meaning that the user's login identifier needs to have a verified relationship with a group-specific identifier for the switch into the verified instance to occur.

In FIG. 5, a user interface 500 illustrates an example of a display screen that is capable of being presented to a user via, e.g., a user system. The user interface 500 illustrates an entity profile page for the same user as FIG. 4 after a switch from an unverified instance to a verified instance associated with a particular group has occurred, e.g., after an entity verification service successfully verifies that the user has a relationship with the group associated with the verified instance.

In some examples, switching from the unverified instance to the verified instance invokes a secure sign-on procedure (e.g., seamless SSO or efficient SSO) to securely transition from the unverified instance to the verified instance.

The user interface 500 includes a group-specific graphic 502 positioned adjacent the user's profile photo. The group-specific graphic 502 provides a clear indication to the user that they are no longer in the unverified instance but rather are operating in the group-specific verified instance. The user interface 500 contains additional messaging 504, 506, informing the user of the limits and restrictions of the group-specific instance and confirming the security level associated with the verified instance, which is different than (e.g., more secure than) the unverified instance.

In some examples, switching from the unverified instance to the verified instance causes the application to hide one or more fields, features, or functionalities that would normally be visible in the unverified instance from view so that they are not visible or accessible by the user in the verified instance. The hidden fields, features, or functionalities that are hidden in the verified instance include those that are not associated with the group.

The user interface 500 also includes a switch mechanism 508. The switch mechanism 508 is a selectable user interface element that, when selected or activated, enables the user to switch from the verified instance back to the unverified instance of the application. Switching from the verified instance to the unverified instance does not entail sharing of information from the verified instance to the unverified instance. Switching from the unverified instance to the verified instance enables selective sharing of information from the unverified instance to the verified instance, in some examples.

In FIG. 6, a user interface 600 illustrates an example of a display screen that is capable of being presented to a user via, e.g., a user system. The user interface 600 illustrates a content delivery event page capable of being presented to a user in a verified instance.

In the illustration of FIG. 6, the content delivery event includes a presentation of job search results obtained by limiting the search to only those jobs available at the company associated with the verified instance. In other words, in the verified instance, content delivery events such as displays of search results are automatically limited to or filtered by the group associated with the verified instance. Thus, in the user interface 600, header information 602 clearly indicates that the search results are limited to such group and provides a link 604 to further information or additional internal jobs.

The user interface 600 includes a filter section 610 by which the user can view all search results (e.g., jobs) returned in the search or a subset of the search results (e.g., only those jobs where the user is a top applicant. With the all jobs filter selected, a facets section 612 enables the user to filter the search results by one or more facets. In some examples, the facets shown in facet section 612 are customized for the group associated with the verified instance, e.g., by using group-specific terminology, attributes, attribute types, jargon, or acronyms.

In FIG. 7, a user interface 700 illustrates an example of a display screen that is capable of being presented to a user via, e.g., a user system. The user interface 700 illustrates a content delivery event page capable of being presented to a user in a verified instance.

In the illustration of FIG. 7, the content delivery event includes a detailed presentation of job recommendations, where recommended jobs are automatically limited to jobs available at the company associated with the verified instance. In the user interface 700, header information 702 clearly indicates that the recommendations are automatically limited to the group associated with the verified instance and that access to the recommendations is restricted to users that have a verified relationship with the group associated with the verified instance. The recommendation list 704 contains recommendations that match the user's verified profile data, e.g., the entity profile data for the user that is available within the verified instance. In the illustrated example, no unverified profile data is used to generate the recommendation list 704. In other examples, e.g., where the recommendation list contains a small number of recommendations, few high click probability recommendations or several low click probability recommendations, the user is prompted for permission to access additional profile information from the unverified instance to improve the recommendations.

In FIG. 8, a user interface 800 illustrates an example of a display screen that is capable of being presented to a user via, e.g., a user system. The user interface 800 illustrates an internal career growth-oriented page capable of being presented to a user in a verified instance.

In the illustration of FIG. 8, the content delivery event includes a conversational natural language dialog-based presentation of recommended topics generated by an artificial intelligence based coach using entity profile information for the user contained within the verified instance.

The user interface 800 includes a header 802, a dialog portion 804, topic suggestions 806, and open ended prompt 808. The header 802 unambiguously informs the user that they are operating in the company-specific verified instance, e.g., by aligning the company logo with the user's profile photo, and that the verified instance is restricted to validated users that have a verified relationship with the company.

The user interface 800 includes a dialog portion 804, which prompts the user for additional information that the AI coaching feature may use to generate or refine content delivery events. Any additional information provided by the user in response to the dialog portion 804 or the open-ended prompt 808 is stored in verified entity profile data, which is only accessible to the verified instance of the application and is inaccessible by the unverified instance of the application.

The user interface 800 includes selectable topic suggestions 806. The topic suggestions are generated by the application system, e.g., via an AI-based agent of the application system, using only information contained in the verified instance (e.g., verified entity profile data) as input to the suggestion generation process. In the illustrated example, no unverified entity profile data is used to generate the topic suggestions 806. In other examples, e.g., where no topic suggestions 806 are available due to a lack of verified entity profile data, the user is prompted for permission to access additional profile information from the unverified instance to improve the topic suggestions.

In some examples, entity profile information external to both the verified and unverified instances is used to supplement the entity profile information in the verified instance. External information includes information obtained from another computer system that is internal to the group, e.g., company, associated with the verified instance, such as an internal employee information system. In some examples, information from such group-specific systems provides additional attribute types that are used to provide additional functionalities within the verified instance that are not available in the unverified instance. In some examples, the additional profile information includes company-specific hierarchies that define organization structures and/or career paths, such as internal departments, divisions, and project teams. Such information is used to generate company-specific content delivery events such as finer-grain or customized connection or follow recommendations. In some examples, the additional profile information available through company systems is used to generate different types of content delivery events that are not available in the unverified instance, such as notifications of personal milestones related to work anniversaries and achievements. This company-specific categories of content delivery events are capable of fostering connections between employees and encouraging dialog around company-specific topics that may not be suitable for sharing on a public-facing forum, e.g., an unverified instance.

The examples shown in FIG. 4, FIG. 5, FIG. 6, FIG. 7, and FIG. 8, and the accompanying description, are provided for illustration purposes. The illustrative examples are adaptable to smaller form factors such as smart phones, tablet computers, or wearable devices, and/or the user interfaces are adaptable to other forms of electronic devices, such as desktop computers and/or laptop devices, or vice versa. This disclosure is not limited to the described examples.

FIG. 9 is a flow diagram of an example method for using cross-instance profile data for selective content delivery in accordance with some examples of the present disclosure.

The method 900 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some examples, portions of the method 900 are performed by one or more of the computing system components shown in FIG. 1, FIG. 2, FIG. 3, FIG. 4, FIG. 5, FIG. 6, one or more components of computing system 1000 of FIG. 10, one or more components of FIG. 11A-11E, using an entity graph such as described with reference to FIG. 12, and/or one or more components of computer system 1300 of FIG. 13. Although shown in a particular sequence or order, unless otherwise specified, the order of the processes is modifiable. In some examples, the processes are performed in a different order, and/or some processes are performed in parallel. Additionally, one or more processes are omitted in some examples. Thus, not all processes are required in every example. Other process flows are possible.

At operation 910, the processing device verifies a relationship between an entity and a group identifier. In some examples, verification is performed by an entity verification service such as entity verification service 110 described with reference to FIG. 1 or entity verification service 210 described with reference to FIG. 2. In some examples, the group identifier is accessible to a first instance of a software application and inaccessible to a second instance of the software application. In some examples, the verified relationship is used to establish whether the first instance can be used to provide the profile data. In some examples, the entity is a single individual, such as a single user of an application software system, e.g., a user who has a verified employment relationship with a company associated with the first instance, where the user also has an account in the second instance, where the second instance is a general purpose or public facing version of the application software system that is not specific to the user's employer.

At operation 920, the processing device establishes a first instance of a software application at a device. In some examples, use of the first instance is restricted to the entity having the verified relationship with the group identifier. In some examples, the first instance is a verified instance, such as verified instance 104 described with reference to FIG. 1, verified instance 204 described with reference to FIG. 2, or verified instance 304 described with reference to FIG. 3. In some examples, establishing the first instance is performed by an instance manager such as instance manager 108 described with reference to FIG. 1, or an instance switcher such as instance switcher 112 described with reference to FIG. 1 or instance switcher 212 described with reference to FIG. 2.

At operation 930, via the first instance, the processing device stores verified profile data for the entity. In some examples, verified profile data includes verified profile data 118 described with reference to FIG. 1, verified profile data 218 described with reference to FIG. 2, or verified profile data 318 described with reference to FIG. 3. In some examples, access to the stored verified profile data is restricted to one or more entities that have a verified relationship with the group identifier. In some examples, storing and access to verified profile data is performed by an instance manager, such as instance manager 108 described with reference to FIG. 1 or instance manager 308 described with reference to FIG. 3, or by a cross-instance data manager such as cross-instance data manager 214 described with reference to FIG. 2.

In some examples, the verified profile data includes first attribute data and the unverified profile data includes second attribute data different from the first attribute data. In some examples, the verified profile data includes a first type of attribute data and the unverified profile data includes a second type of attribute data different from the first type of attribute data. In some examples, the verified profile data includes first interaction data limited to interactions of the entity with other entities associated with the group identifier and the unverified profile data includes second interaction data different from the first interaction data. In some examples, the verified profile data is inaccessible to the second instance of the software application. In some examples, the attribute data, attribute type data, and/or interaction data include data described with reference to FIG. 3.

At operation 940, the processing device provides unverified profile data to the first instance. In some examples, unverified profile data includes unverified profile data 120 described with reference to FIG. 1, unverified profile data 220 described with reference to FIG. 2, or unverified profile data 330 described with reference to FIG. 3.

In some examples, the verified and unverified data contain different values for a same or similar attribute. In some examples, verified data includes job titles or job descriptions that are specific to a particular group, while unverified data includes job titles and descriptions for other jobs that are not specific to that particular group, e.g., job titles and descriptions of jobs associated with one or more other groups. The verified and unverified data contain different attribute types. In some examples, the verified data includes group-specific information such as internal department/division information, acronyms, or jargon, and the unverified data contains information that is group-independent or not specific to the group, such as volunteer activities. In some examples, the verified interaction data is limited to interaction data involving use of the first instance of the software application by verified users associated with the group identifier, while the unverified interaction data includes interaction data involving use of the second instance of the software applications by other users not associated with the group identifier.

In some examples, examples of the unverified profile data include profile data associated with another account that has access to the first instance, profile data associated with other entities that have verified relationships with the group associated with the first instance (e.g., other employees of the company associated with the first, group-specific instance), and/or profile data associated with other entities that do not have verified relationships with the group associated with the first instance, such as other users of the second instance, e.g., users who work in the same industry or region as the entity.

In some examples, the unverified profile data is obtained from a second instance of the software application. In some examples, the second instance is an unverified instance such as unverified instance 106 described with reference to FIG. 1, unverified instance 206 described with reference to FIG. 2, or unverified instance 306 described with reference to FIG. 3. In some examples, the second instance does not have access to any of the verified data stored in association with the first instance. In some examples, the second instance of the software application is a public-facing or non-private version of the software application. In some examples, the second instance is another secure version of the software application that is different from the first instance. In some examples, the first instance is a secure, group-specific instance of the software application associated with a first group (e.g., a first company) and the second instance is another secure, group-specific instance of the software application associated with a second group (e.g., a different company from the first company). In some examples, the entity is a user that is associated with both the first company and the second company, where the first and second companies are different companies that each have their own secure, group-specific instances of the software application.

In some examples, the first instance is to use the verified profile data and the unverified profile data to cause a content delivery event for the entity at the device via the first instance. In some examples, unverified profile data is obtained from a second instance and provided to the first instance by an instance manager, such as instance manager 108 described with reference to FIG. 1 or instance manager 308 described with reference to FIG. 3, or by a cross-instance data manager such as cross-instance data manager 214 described with reference to FIG. 2. In some examples, causing a content delivery event using the verified profile data and the unverified profile data is performed by an instance manager, such as instance manager 108 described with reference to FIG. 1 or instance manager 308 described with reference to FIG. 3, or by a cross-instance data manager such as cross-instance data manager 214 described with reference to FIG. 2.

In some examples, when there are multiple vertical applications within the first, e.g., verified instance, data can be shared between the verticals within the first instance. In some examples, the first instance of the software application includes a first sub-application and a second sub-application, and the processing device generates the verified profile data via the first sub-application, and uses the verified profile data generated via the first sub-application to generate the content delivery event. In some examples, the content delivery event is generated via the second sub-application. In some examples, the first sub-application includes a search engine, a recommendation engine, an online learning platform, a connections network, a messaging system, a notification center, or a digital content feed, and the second sub-application is different from the first sub-application.

In some examples, the processing device uses a machine learning model to generate the content delivery event for the entity. In some examples, the machine learning model is trained using data specific to the group identifier. In some examples, the machine learning model includes a recommendation engine that is trained on group-specific information such as jargon and acronyms that are internal to a specific company. In some examples, executing the content delivery event includes filtering digital content using a criterion associated with the group identifier. In some examples, the filtering criterion includes a company-specific criterion such as a company-specific attribute type.

In some examples, the processing device receives an input via the first instance; and using the input, switches the entity from use of the first instance of the software application via a first entity identifier associated with the group identifier to use of the second instance of the software application via a second entity identifier. In some examples, the first instance is inaccessible via the second entity identifier. In some examples, different identifiers are used or required to switch between the first and second instances. In some examples, the second or unverified instance does not have access to the group identifier.

In some examples, the unverified profile data is associated with the second instance, the entity, and a second group identifier different from the first group identifier. In some examples, data of the unverified profile data is used to supplement a graph database for the verified profile data.

The examples shown in FIG. 9 and the accompanying description are provided for illustration purposes. This disclosure is not limited to the described examples.

FIG. 10 is a block diagram of a computing system that includes an instance manager system in accordance with some examples of the present disclosure.

In the example of FIG. 10, a computing system 1000 includes one or more user systems 1010, a network 1020, an application system 1030, data resources and tools 1050, an instance manager system 1080, a data storage system 1060, an event logging service 1070, and an AI model service 1090.

All or at least some components of instance manager system 1080 are implemented at the user system 1010, in some examples. For example, portions of instance manager system 1080 are implemented directly upon a single client device such that communications involving applications running on user system 1010 and instance manager system 1080 occur on-device without the need to communicate with, e.g., one or more servers, over the Internet. Dashed lines are used in FIG. 10 to indicate that all or portions of instance manager system 1080 are capable of being implemented directly on the user system 1010, e.g., the user's client device. In some examples, both user system 1010 and instance manager system 1080 are implemented on the same computing device, in some examples. In other examples, all or portions of instance manager system 1080 are implemented on one or more servers and in communication with user systems 1010 via network 1020. Components of the computing system 1000 including the instance manager system 1080 are described in more detail herein.

A user system 1010 includes one or more computing devices. Examples of computing devices include a personal computing device, a server, a mobile computing device, a wearable electronic device, or a smart appliance. The user system 1010 includes one or more software applications that a computing device is capable of executing alone or in combination with one or more other computing devices. Examples of software applications include an operating system or a front end of an online system. Many different user systems 1010 are capable of being connected to network 1020 at the same time or at different times. In some examples, different user systems 1010 contain similar components as described in connection with the illustrated user system 1010. In some examples, many different end users of computing system 1000 interact with many different instances of application system 1030 through their respective user systems 1010, at the same time or at different times.

User system 1010 includes a user interface 1012. User interface 1012 is installed on user system 1010 or accessible to user system 1010 via network 1020. In some examples, user interface 1012 includes a front end portion of a search application or instance manager system.

User interface 1012 includes, for example, a graphical display screen that includes graphical user interface elements. Examples of graphical user interface elements include an input box or other input mechanism and a slot. A slot as used herein refers to a space on a graphical display such as a web page or mobile device screen, into which output, e.g., digital content such as search results, feed items, chat boxes, or threads, is loaded for display to the user. In some examples, user interface 1012 includes a scrollable arrangement of variable-length slots that simulates an online chat or instant messaging session and/or a scrollable arrangement of slots that contain content items or search results. The locations and dimensions of a particular graphical user interface element on a screen are specified using, for example, a markup language such as HTML (Hypertext Markup Language). On a typical display screen, a graphical user interface element is defined by two-dimensional coordinates. In other examples such as virtual reality or augmented reality examples, a slot is defined using a three-dimensional coordinate system. Example screen captures of user interface screens that are capable of being included in user interface 1012 are shown in the drawings and described herein.

User interface 1012 is capable of interacting with the instance manager system 1080 and/or one or more application systems 1030. For example, user interface 1012 enables the user of a user system 1010 to interact with the instance manager system 1080 to create, edit, send, view, receive, process, and organize projects, tasks, plans, search queries, search results, content items, news feeds, and/or portions of online dialogs. In some examples, user interface 1012 enables the user to input requests (e.g., queries) for various different types of information, to initiate user interface events, and to view or otherwise perceive output such as data and/or digital content produced by, e.g., an application system 1030, instance manager system 1080, content distribution service 1038 and/or search engine 1040. In some examples, user interface 1012 includes a graphical user interface (GUI), a conversational voice/speech interface, a virtual reality, augmented reality, or mixed reality interface, and/or a haptic interface. User interface 1012 includes a mechanism for entering search queries and/or selecting search criteria (e.g., facets, filters, etc.), selecting GUI user input control elements, and interacting with digital content such as search results, entity profiles, posts, articles, feeds, and online dialogs, in some examples. Some examples of user interface 1012 include web browsers, command line interfaces, and mobile app front ends. User interface 1012 as used herein includes application programming interfaces (APIs) in some examples.

Network 1020 includes an electronic communications network. Network 1020 is implemented on any medium or mechanism that provides for the exchange of digital data, signals, and/or instructions between the various components of computing system 1000. Examples of network 1020 include, without limitation, a Local Area Network (LAN), a Wide Area Network (WAN), an Ethernet network or the Internet, or a terrestrial, satellite or wireless link, or a combination of any number of different networks and/or communication links.

Application system 1030 includes, for example, one or more online systems that provide social network services, general-purpose search engines, specific-purpose search engines, messaging systems, content distribution platforms, e-commerce software, enterprise software, or any combination of any of the foregoing or other types of software. Application system 1030 includes any type of application system that provides or enables the retrieval of and interactions with one or more forms of digital content, including machine-generated content via user interface 1012. In some examples, portions of instance manager system 1080 are components of application system 1030. In some examples, an application system 1030 includes one or more of an entity graph 1032 and/or knowledge graph 1034, a user connection network 15315, a content distribution service 1038, and/or a search engine 1040. In other examples, application system 1030 interacts with instance manager system 1080 to control a physical machine or device, such as a vehicle or a robot.

In some examples, a front end portion of application system 1030 operates in user system 1010, for example as a plugin or widget in a graphical user interface of a web application, mobile software application, or as a web browser executing user interface 1012. In an example, a mobile app or a web browser of a user system 1010 transmits a network communication such as an HTTP request over network 1020 in response to user input that is received through a user interface provided by the web application, mobile app, or web browser, such as user interface 1012. A server running application system 1030 receives the input from the web application, mobile app, or browser executing user interface 1012, performs one or more operations using the input, and returns output to the user interface 1012 using a network communication such as an HTTP response, which the web application, mobile app, or browser receives and processes at the user system 1010.

In the example of FIG. 10, an application system 1030 includes an entity graph 1032 and/or a knowledge graph 1034. Entity graph 1032 and/or knowledge graph 1034 include data organized according to graph-based data structures that are searchable or traversable via queries and/or indexes to determine relationships between entities. In some examples, entity graph 1032 and/or knowledge graph 1034 is used to compute various types of relationship weights, affinity scores, similarity measurements, and/or statistics between, among, or relating to entities.

Entity graph 1032, knowledge graph 1034 includes a graph-based representation of data stored in data storage system 1060, described herein. For example, entity graph 1032, knowledge graph 1034 represents entities, such as users, organizations (e.g., companies, schools, institutions), content items (e.g., job postings, announcements, articles, comments, and shares), and computing resources (e.g., databases, models, applications, and services), as nodes of a graph. Entity graph 1032, knowledge graph 1034 represents relationships, also referred to as mappings or links, between or among entities as edges, or combinations of edges, between the nodes of the graph. In some examples, mappings between different pieces of data used by an application system 1030 are represented by one or more entity graphs. In some examples, the edges, mappings, or links indicate relationships, online interactions, or activities relating to the entities connected by the edges, mappings, or links. In some examples, if a user clicks on a search result, an edge is created connecting the user entity with the search result entity in the entity graph, where the edge is tagged with a label such as “viewed.” If a user viewing a list of search results skip over a search result without clicking on the search result, an edge is not created between the user entity and the search result entity in the entity graph, in some examples.

Portions of entity graph 1032, knowledge graph 1034 are automatically re-generated or updated from time to time based on changes and updates to the stored data, e.g., updates to entity data and/or activity data. In some examples, entity graph 1032, knowledge graph 1034 refers to an entire system-wide entity graph or to only a portion of a system-wide graph. In some examples, entity graph 1032, knowledge graph 1034 refers to a subset of a system-wide graph, where the subset pertains to a particular user or group of users of application system 1030.

Knowledge graph 1034 includes a graph-based representation of data stored in data storage system 1060, described herein. Knowledge graph 1034 represents relationships, also referred to as links or mappings, between entities or concepts as edges, or combinations of edges, between the nodes of the graph. In some examples, mappings between different pieces of data used by application system 1030 or across multiple different application systems are represented by the knowledge graph 1034.

In some examples, knowledge graph 1034 is a subset or a superset of entity graph 1032. In some examples, knowledge graph 1034 includes multiple different entity graphs 1032 that are joined by cross-application or cross-domain edges. In some examples, knowledge graph 1034 joins entity graphs 1032 that have been created across multiple different databases or across different software products. In some examples, the entity nodes of the knowledge graph 1034 represent concepts, such as product surfaces, verticals, or application domains. In some examples, knowledge graph 1034 includes a platform that extracts and stores different concepts that is used to establish links between data across multiple different software applications. Examples of concepts include topics, industries, and skills. As with other portions of entity graph 1032, knowledge graph 1034 is usable to compute various types of relationship weights, affinity scores, similarity measurements, and/or statistical correlations between or among entities and/or concepts.

In the example of FIG. 10, application system 1030 includes a user connection network 1036. User connection network 1036 includes, for instance, a social network service, professional social network system and/or other social graph-based applications. Content distribution service 1038 includes, for example, a feed, chatbot or chat-style system, or a messaging system, such as a peer-to-peer messaging system that enables the creation and exchange of messages between users of application system 1030 and the application system 1030. Search engine 1040 includes a search engine that enables users of application system 1030 to input and execute search queries to retrieve information from one or more sources of information, such as user connection network 1036, entity graph 1032, knowledge graph 1034, one or more data stores of data storage system 1060, or one or more data resources and tools 1050.

In the example of FIG. 10, application system 1030 includes a content distribution service 1038. The content distribution service 1038 includes a data storage service, such as a web server, which stores digital content items, and transmits digital content items to users via user interface 1012. In some examples, content distribution service 1038 processes requests from, for example, application system 1030 and/or instance manager system 1080, and distributes digital content items to user systems 1010 in response to requests.

A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, an input of a search query, or a page load. In some examples, content distribution service 1038 is part of application system 1030. In other examples, content distribution service 1038 interfaces with application system 1030 and/or instance manager system 1080, for example, via one or more application programming interfaces (APIs).

In the example of FIG. 10, application system 1030 includes a search engine 1040. Search engine 1040 includes a software system designed to search for and retrieve information by executing queries on one or more data stores, such as databases, connection networks, and/or graphs. The queries are designed to find information that matches specified criteria, such as keywords and phrases contained in user input and/or system-generated queries. For example, search engine 1040 is used to retrieve data in response to user input and/or system-generated queries, by executing queries on various data stores of data storage system 1060 and/or data resources and tools 1050, or by traversing entity graph 1032, knowledge graph 1034.

Data resources and tools 1050 include computing resources, such as data stores, databases, embedding-based retrieval mechanisms, code generators, etc., that are capable of being used to operate an application software system and/or instance manager system. Data resources and tools 1050 include computing resources that are internal to application system 1030 or external to application system 1030. Examples of data resources and tools 1050 include entity graphs, knowledge graphs, indexes, databases, networks, applications, models (e.g., large language models and/or other artificial intelligence models or machine learning models), taxonomies, data services, web pages, vectors (e.g., data stores that store embeddings), and searchable digital catalogs. Each data resource or tool 1050 enables an application software system and/or instance manager system to access the data resource or tool, for example by providing an application programming interface (API). Each data resource or tool 1050 includes a monitoring service that periodically generates, publishes, or broadcasts availability and/or other performance metrics associated with the data resource, in some examples. A data resource or tool 1050 provides a set of APIs that are used by an application software system and/or instance manager system to access the data resource or tool, obtain output from the data resource, and/or obtain performance metrics for the data resource or tool, in some examples.

Data storage system 1060 includes data stores and/or data services that store digital data received, used, manipulated, and produced by application system 1030 and/or instance manager system 1080, including contextual data, state data, prompts and/or prompt templates for generative artificial intelligence models or large language models, user inputs, system-generated outputs, metadata, attribute data, activity data. Databases or data stores that are capable of being used in some of the described examples include but are not limited to vector databases, graph databases, relational databases, and key-value stores.

In the example of FIG. 10, data storage system 1060 includes various data stores that store, for example, entity data, context data, prompts, embeddings, etc. A data store includes include a volatile memory such as a form of random access memory (RAM) and/or persistent memory, which can be available on user system 1010 or another device (e.g., one or more servers) for storing state data generated at the user system 1010 or an application system 1030. In some examples, a separate, personalized version of each or any data store is created for each user such that data is not shared between or among the separate, personalized versions of the data stores.

In some examples, data storage system 1060 includes multiple different types of data storage and/or a distributed data service. In some examples, data service refers to a physical, geographic grouping of machines, a logical grouping of machines, or a single machine. In some examples, a data service includes a data center, a cluster, a group of clusters, or a machine. Data stores of data storage system 1060 are capable of storing data produced by real-time and/or offline (e.g., batch) data processing. A data store configured for real-time data processing is referred to as a real-time data store, in some examples. A data store configured for offline or batch data processing is referred to as an offline data store, in some examples. Data stores are capable of being implemented using databases, such as key-value stores, relational databases, and/or graph databases. Data is written to and read from data stores using query technologies, e.g., SQL or NoSQL.

Data storage system 1060 resides on one or more persistent and/or volatile storage devices that reside within the same local network as other devices of computing system 1000 and/or in a network that is remote relative to other devices of computing system 1000. Thus, although depicted as being included in computing system 1000, portions of data storage system 1060 are part of computing system 1000 or accessed by computing system 1000 over a network, such as network 1020, in some examples.

Event logging service 1070 captures and records activity data generated during operation of application system 1030 and/or instance manager system 1080, including user interface events generated at user systems 1010 via user interface 1012, in real time, and formulates the user interface events and/or other network activity data into a data stream that is consumed by, for example, a stream processing system. Examples of network activity data include logins, page loads, dialog inputs, input of search queries or query terms, selections of facets or filters, clicks on search results or graphical user interface control elements, scrolling lists of search results, and social action data such as likes, shares, comments, and social reactions (e.g., “insightful,” “curious,” “like,” etc.). For instance, when a user of application system 1030 via a user system 1010 enters input or clicks on a user interface element, such as a workflow element, or a user interface control element such as a view, comment, share, or reaction button, or uploads a file, or inputs a query, or scrolls through a feed, etc., event logging service 1070 fires an event to capture and store log data including an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web applications and mobile applications.

For instance, when a user enters input or reacts to system-generated output, such as a list of search results, event logging service 1070 stores the corresponding event data in a log. Event logging service 1070 generates a data stream that includes a record of real-time event data for each user interface event that has occurred. Event data logged by event logging service 1070 is pre-processed and anonymized as needed so that it is capable of being used as context data to, for example, configure one or more instructions for one or more artificial intelligence models (e.g., large language models), or to modify weights, affinity scores, or similarity measurements that are assigned by the instance manager system to search results or data resources.

Instance manager system 1080 includes any one or more of the components, features, or functions described herein with respect to an instance manager system. For example, instance manager system 1080 includes components of an instance manager system such as described with reference to FIG. 1, FIG. 2, FIG. 3, FIG. 4, FIG. 5, FIG. 6, FIG. 7, FIG. 8, and/or FIG. 9.

AI model service 1090 includes one or more artificial intelligence-based models, such as large language models and/or other types of machine learning models including discriminative and/or generative models, neural networks, probabilistic models, statistical models, transformer-based models, and/or any combination of any of the foregoing. In some examples, AI model service 1090 enables an application software system and/or instance manager system to access to these models, for instance by providing one or more application programming interfaces (APIs). AI model service 1090 includes a monitoring service that periodically generates, publishes, or broadcasts latency and/or other performance metrics associated with the models. In some examples, AI model service 1090 provides a set of APIs that are used by an application software system and/or instance manager system to obtain performance metrics for large language models and/or other machine learning models.

While not specifically shown, it should be understood that any of user system 1010, application system 1030, data resources and tools 1050, data storage system 1060, event logging service 1070, instance manager system 1080, and AI model service 1090 includes an interface embodied as computer programming code stored in computer memory that when executed causes a computing device to enable bidirectional communication with any other of user system 1010, application system 1030, data resources and tools 1050, data storage system 1060, event logging service 1070, instance manager system 1080, and AI model service 1090 using a communicative coupling mechanism. Examples of communicative coupling mechanisms include network interfaces, inter-process communication (IPC) interfaces and application program interfaces (APIs).

Each of user system 1010, application system 1030, data resources and tools 1050, data storage system 1060, event logging service 1070, instance manager system 1080, and AI model service 1090 is implemented using one or more computing devices that are communicatively coupled to electronic communications network 1020. Any of user system 1010, application system 1030, data resources and tools 1050, data storage system 1060, event logging service 1070, instance manager system 1080, and AI model service 1090 are capable of being bidirectionally communicatively coupled by network 1020. User system 1010 as well as other different user systems (not shown) are bidirectionally communicatively coupled to application system 1030 and/or instance manager system 1080, in some examples.

Examples of users of user system 1010 include an administrator or end user of application system 1030 or instance manager system 1080. User system 1010 is configured to communicate bidirectionally with any of application system 1030, data resources and tools 1050, data storage system 1060, event logging service 1070, instance manager system 1080, and AI model service 1090 over network 1020.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 1010, application system 1030, data resources and tools 1050, data storage system 1060, event logging service 1070, instance manager system 1080, and AI model service 1090 are implemented using computer software, hardware, or software and hardware, and include combinations of automated functionality, data structures, and digital data, which are represented schematically in the figures. User system 1010, application system 1030, data resources and tools 1050, data storage system 1060, event logging service 1070, instance manager system 1080, and AI model service 1090 are shown as separate elements in FIG. 15 for ease of discussion but, except as otherwise described, the illustration is not meant to imply that separation of these elements is required. The illustrated systems, services, and data stores (or their functionality) of each of user system 1010, application system 1030, data resources and tools 1050, data storage system 1060, event logging service 1070, instance manager system 1080, and AI model service 1090 are capable of being divided over any number of physical systems, including a single physical computer system, and are capable of communicating with each other in any appropriate manner.

In the example of FIG. 13, portions of instance manager system 1080 that are capable of being implemented on a front end system, such as one or more user systems, and portions of instance manager system 1080 that are capable of being implemented on a back end system such as one or more servers, are collectively represented as instance manager system 1350 for ease of discussion only. In some examples, portions of instance manager system 1080 are not required to be implemented all on the same computing device, in the same memory, or loaded into the same memory at the same time. In some examples, access to portions of instance manager system 1080 is limited to different, mutually exclusive sets of user systems and/or servers. In some examples, a separate, personalized version of instance manager system 1080 is created for each user of the instance manager system 1080 such that data is not shared between or among the separate, personalized versions of the instance manager system 1080. Certain portions of instance manager system 1080 are capable of being implemented on user systems while other portions of instance manager system 1080 are capable of being implemented on a server computer or group of servers. In some examples, one or more portions of instance manager system 1080 are implemented on user systems. Instance manager system 1080 is entirely implemented on user systems, e.g., client devices, in some examples. In some examples, a version of instance manager system 1080 is embedded in a client device's operating system or stored at the client device and loaded into memory at execution time.

The examples shown in FIG. 10 and the accompanying description, above are provided for illustration purposes. This disclosure is not limited to the described examples.

FIG. 11A, FIG. 11B, FIG. 11C, FIG. 11D, and FIG. 11E are block diagrams of examples of machine learning models that are usable by and/or included in an application software system or instance manager system in accordance with some examples of the present disclosure.

FIG. 11A is a block diagram of a machine learning modeling system that is capable of being used by and/or included in an application software system or instance manager system in accordance with some examples of the present disclosure.

Machine learning models are computer-implemented structures that are capable of generating predictive output in response to raw input. A machine learning model includes a probabilistic or statistical algorithm that is configured to perform a specific predictive function through a training process that involves iteratively exposing the models to many samples of data and adjusting one or more model parameters until the models achieve a satisfactory prediction accuracy and reliability. The predictive accuracy and reliability of a machine learning model in relation to a particular task is dependent upon the training process and the data used in the training.

Machine learning systems include components and processes that perform data generation, model training, model evaluation (e.g., calibration and validation), and application. Data preparation includes obtaining and aggregating model input data. The preparation of training data includes labeling the aggregated data, in some examples. Training data includes structured data, unstructured data, text, multimodal data, or any combination of any of the foregoing. Model training includes setting values of hyperparameters, determining performance metrics, adjusting weights of the machine learning model in response to the training data, evaluating the performance metrics, and parameter tuning. Application includes applying the trained machine learning model to the real-world environment, e.g., in a specific use case using data not included in the training data (e.g., unlabeled data). The application phase is referred to as inferencing or inference time, in some examples.

In FIG. 11A, a machine learning modeling system 1100 includes a machine learning model 1106, a modeling and calibration subsystem 1102, and a model validation subsystem 1104. The machine learning model 1106 is any type or combination of one or more machine learning models, such as any of the types of machine learning models shown in FIG. 11B, FIG. 11C, FIG. 11D, and FIG. 11E and/or any other types or combinations of machine learning models.

The modeling and calibration subsystem 1102 receives model input, such as input feature sets, embeddings, digital content, or prompts. The model input is engineered to train the machine learning model 1106 to perform one or more tasks, such as discriminative tasks like classification or scoring and/or generative tasks such as content generation tasks. Modeling and calibration subsystem 1102 includes a data set creation component 1103, a model training component 1105, and a model calibration component 1107.

Data set creation component 1103 divides the model input, e.g., input feature sets, into one or more training data sets and one or more validation data sets, e.g., training data set 1109 and validation data set 1111. Model training component 1105 and model calibration component 1107 cooperatively execute a training process. In some examples, the training process causes the machine learning model 1106 to develop, by iterative adjustments to weights or coefficients, a mathematical representation of the relationships between different items of data, such as relationships between different inputs (e.g., similarity estimates or estimates of user preferences), or relationships between inputs and categorical data such as classification labels, or relationships between inputs and outputs. The resulting trained model is used to generate predictive output (e.g., scores, labels, or other output) based on subsequent model input.

One or more different approaches are used to train the machine learning model 1106, for example, supervised machine learning, semi-supervised machine learning, or unsupervised machine learning. In supervised machine learning, the set of training data includes indications of expected model output coupled with respective model input; for example, ground-truth labeled data samples. In some examples, an instance of training data for supervised learning includes a model input (e.g., a set of features) and an associated expected output (e.g., a classification label), where the expected output is human curated or machine-generated. In some examples, an instance of training data for supervised machine learning includes a digital image and a title or caption for the image that describes the contents of the image. In unsupervised machine learning, the training examples are unlabeled. In unsupervised machine learning, a machine learning algorithm such as a clustering algorithm is used to identify similarities among data samples and create clusters or groupings of similar data using one or more similarity criteria. In some examples, unsupervised learning is used to group digital content items, such as images, articles, or videos, into topics, where the topics are determined based on the features of the content items themselves rather than supplied by labels. Semi-supervised machine learning combines supervised and unsupervised machine learning, using both labeled and unlabeled data to train machine learning models.

Model training component 1105 applies machine learning model 1106 to training data set 1109 iteratively and adjusts the value of one or more model parameters and/or feature coefficients of the machine learning model 1106 based on the processing of the training data set 1109 by the model 1106 until the difference between the predicted model output generated by the machine learning model 1106 and the expected model output evidenced by the training data set 1109 satisfies (e.g., meets or exceeds) model performance criteria 1108. When the model performance criteria 1108 are satisfied, modeling and calibration subsystem 1102 ends the model training process and produces a trained machine learning model 1106.

Model validation subsystem 1104 applies a model validation process to the trained machine learning model 1106 produced by modeling and calibration subsystem 1102. Model validation subsystem 1104 uses the validation data set 1111 to determine whether model validation criteria 1110 are satisfied (e.g., met or exceeded). In some examples, the validation data set 1111 is created by setting aside a portion of the training data set 1109 until after training, such that the validation data set 1111 is used to compare and evaluate the difference between the predictive output produced by the trained model to the expected model output evidenced by the set-aside portion of the training data set 1109.

A validated machine learning model 1106 is used for inferencing, e.g., to generate predictive output, e.g., labels, scores, or other content, in response to model input. Alternatively or in addition, the output produced by the validated machine learning model 1106 is stored for future use (e.g., for access or lookup by one or more downstream processes, systems, or services).

There are many different types and configurations of machine learning models. Illustrative, nonlimiting examples of some of the different types of machine learning models are shown in FIG. 11B, FIG. 11C, FIG. 11D, and FIG. 11E, described below. The AIs, models, and AI model services described herein are capable of including or using any of the various types of machine learning models, including but not limited to one or more of the types of models shown in FIG. 11B, FIG. 11C, FIG. 11D, and FIG. 11E.

The examples shown in FIG. 11A and the accompanying description, above are provided for illustration purposes. This disclosure is not limited to the described examples.

FIG. 11B is a block diagram of a machine learning model that is capable of being used by and/or included in an application software system or instance manager system in accordance with some examples of the present disclosure.

In the example of FIG. 11B, a machine learning system 1112 includes a machine learning model 1115. Machine learning model 1115 is or includes a probabilistic or statistical machine learning model that uses a modeling function 1116 to model the relationship between model input 1114 (e.g., input feature set X) and model output (e.g., Y, P(Y|X)).

In some examples, the machine learning model 1115 is configured as a discriminative model such that the machine learning model 1115 produces output that indicates the probabilistic or statistical likelihood of an output Y given an input X. Some examples of the machine learning model 1115 are alternatively or additionally configured as a generative model. In some examples, a machine learning model performs both discriminative and generative tasks.

One illustrative example of a discriminative model is a logistic regression function. Mathematically, a simplified form of the logistic function is capable of being expressed as

$$P ( X ) = f ( x ) = \frac{1}{1 + {e}^{- ( {β}_{0} + {β}_{1} x )}} ,$$

where e is the exponential constant and β₀ and β₁ are feature coefficients. During training of the logistic regression model 1115, logistic regression estimates the values of the coefficients in the linear combination based on the feature values in the training data set. The machine learning model 1115 is configured (e.g., values of model parameters are adjusted) via training, calibration, and validation processes such as those described with reference to FIG. 11A.

The machine learning model 1115 includes a modeling function 1116. The modeling function 1116 includes feature coefficients 1117. The values of one or more of the feature coefficients 1117 are established via machine learning model training, calibration, and validation processes based on training data sets and/or validation data sets.

In the logistic regression example, the feature coefficients 1117 include a regression coefficient β for each feature input x (e.g., f(i)=β₀+β₁x_{1,i}+ . . . βₘx_{m,i}), where xᵢ is a particular item of the feature set and m is the number of feature inputs x in the input feature set X 1114. The regression coefficient indicates the relative effect of the particular feature input x of the feature set X on the predicted outcome P(Y|X), e.g., a predicted label or score, based on the values of the feature inputs x in the feature set X 1114. The values of the feature coefficients are initialized and adjusted during model training and calibration.

The machine learning model 1115 also includes model hyperparameters 1118. The values of hyperparameters 1118 are selected or tuned at a global level and generally are not modified based on specific instances of training data. In the logistic regression example, model hyperparameters 1118 include a penalty or regularization parameter (e.g., L1 or L2) and the C or regularization strength parameter. The penalty or regularization parameter is tunable to adjust model generalization error and regulate overfitting. The C or regularization strength parameter regulates overfitting in conjunction with the penalty. The model hyperparameters 1118 is tuned using, for example, a hyperparameter tuning tool or hyperparameter optimization method.

Some examples of the machine learning model 1115 are configured as a binary classifier or as a scoring model. In a binary classification mode, the output of the machine learning model 1115 indicates whether the model input is or is not associated with a certain output (e.g., either 0 if the input is not mathematically likely to be associated with the output or 1 if the input is mathematically likely to be associated with the output), for a given set of input features. In a scoring mode, the output of the machine learning model 1115 includes a score, which corresponds to a probability of the predicted output (e.g., a numerical value between zero and 1, inclusive).

The model input 1114 (e.g., input feature set X) includes numerical features, categorical features, quantitative values, qualitative values, raw features, compressed representations of raw features (e.g., vector representations or embeddings, and/or other forms of digital content.

In response to an instance of features of feature set X, machine learning model 1115 computes and outputs an estimated output P Y|X) 1119. The estimated output produced by machine learning model 1115 based on an instance of features of feature set X 1114 is in the form of a binary output or a score, in some examples. The output is stored in a data storage for subsequent lookup or provided to one or more downstream systems, processes, devices, frameworks, and/or services.

The machine learning model 1115 is configured and implemented as a network service, in some examples. In some examples, the machine learning model 1115 is configured using a machine learning library and an application programming interface (API), e.g., via an API call such as ML_library.model(p1, p2, . . . pn), where p indicates a parameter or argument of the call, such as a model hyperparameter or an input feature set identifier. Once configured, the machine learning model 1115 and/or its output is hosted on one or more servers and/or data storage devices for accessibility to one or more requesting processes, systems, devices, frameworks, or services.

The examples shown in FIG. 11B and the accompanying description, above are provided for illustration purposes. This disclosure is not limited to the described examples.

FIG. 11C is a block diagram of a machine learning model that is capable of being used by and/or included in an application software system or instance manager system in accordance with some examples of the present disclosure.

A generative machine learning model (GMLM) or generative model uses artificial intelligence technology, e.g., machine learning, neural networks, to machine-generate digital content based on model inputs and the previously existing data with which the model has been trained. Whereas discriminative models are based on conditional probabilities P(y|x), that is, the probability of an output y given an input x, generative models capture joint probabilities P(x, y), that is, the likelihood of x and y occurring together. A generative language model is a particular type of GMLM that is capable of generating content in response to model input. The model input includes a task description, also referred to as a prompt. The task description includes instructions (e.g., natural language instructions such as “please generate a summary of these search results”) and/or examples of digital content (e.g., examples of summaries written using a particular writing style or tone). Portions of the task description are in the form of natural language text, such as a question or a statement, in some examples. Alternatively or in addition, a task description or prompt includes non-text forms of content, such as digital imagery and/or digital audio.

In the example of FIG. 11C, a machine learning system 1120 includes a machine learning model 1124. Machine learning model 1124 is or includes a probabilistic or statistical machine learning model that uses a modeling function to model the likelihood of cooccurrence of input feature set X and output Y; e.g., the likelihood of X and Y occurring together. The machine learning model 1124 is configured via training, calibration, and validation processes such as those described with reference to FIG. 11A. Some examples of the machine learning model 1124 are alternatively or additionally configured as a discriminative model. In some examples, a machine learning model performs both discriminative and generative tasks.

The machine learning model 1124 includes a modeling function 1125. The modeling function 1125 includes feature coefficients or weights 1126. The values of one or more of the feature coefficients is established via machine learning model training, calibration, and validation processes based on training data sets and/or validation data sets. The machine learning model 1124 also includes model hyperparameters 1127. The values of model hyperparameters 1127 are selected or tuned at a global level and generally are not modified based on specific instances of training data.

The model input 1122 (e.g., input feature set X) includes numerical features, categorical features, quantitative values, qualitative values, raw features, compressed representations of raw features (e.g., vector representations or embeddings), and/or other forms of digital content.

In response to an instance of model input 1122 (e.g., instance of feature set X), machine learning model 1124 computes and outputs an estimated output P(X,Y) 1128. The estimated output produced by machine learning model 1124 based on a model input 1122 is in the form of an input-output pair and a score or simply includes the highest scoring input-output pair. In some examples, the output is stored in a data storage for subsequent lookup or provided to one or more downstream systems, processes, devices, frameworks, and/or services.

The machine learning model 1124 is configured and implemented as a network service, in some examples. The machine learning model 1124 is configured using a machine learning library and an application programming interface (API), e.g., via an API call such as ML_library.model(p1, p2, . . . pn), where p indicates a parameter or argument of the call, such as a model hyperparameter or an input feature set identifier, in some examples. Once configured, the machine learning model 1124 and/or its output are hosted on one or more servers and/or data storage devices for accessibility to one or more requesting processes, systems, devices, frameworks, or services.

The examples shown in FIG. 11C and the accompanying description, above are provided for illustration purposes. This disclosure is not limited to the described examples.

FIG. 11D is a block diagram of a machine learning model that is capable of being used by and/or included in an application software system or instance manager system in accordance with some examples of the present disclosure.

A specific example of a machine learning model is a deep neural network. Some machine learning models, such as multi-task models, include multiple interconnected deep neural networks. In the example of FIG. 11D, a machine learning system 1130 includes a deep neural network 1134. The deep neural network 1134 is configured via training, calibration, and validation processes such as those described with reference to FIG. 11A. Some examples of the deep neural network 1134 are configured as a discriminative model and/or a generative model. In some examples, a deep neural network 1134 performs both discriminative and generative tasks.

In computer science, deep learning refers to a class of machine learning that uses computer-implemented neural networks to generate predictive output, where the neural networks have one or more internal (or hidden) layers between and in addition to an input layer and an output layer. Each layer in a deep neural network (or deep learning model) performs a set of computational operations on the input to that layer.

Each layer of the neural network includes a set of nodes that each apply an activation function to one or more portions of the input to that layer to produce an output. The activation function performs a nonlinear transformation of the input and sends its output to the next layer of the network. For example, if the output of the activation function is equal to or exceeds a threshold value, the node passes its output to the next layer, but if the output is less than the threshold value, the output passed to the next layer is zero or a null value. The type of activation function used at a node or layer is selected based on the particular predictive task for which the model is configured and/or based on the model architecture. Examples of activation functions include the SoftMax function (for multi-class classification), the sigmoid function (for internal layers), and rectifier functions (e.g., ramp, or Rectified Linear Unit (ReLU)).

The input layer of a deep neural network receives and processes the model input, which includes raw data and/or pre-processed data such as aggregations, derivations, embeddings or vector representations of raw data. In some examples, the output of a layer of the neural network is connected to and used as the input to one or more other layers, such that each layer of the deep learning model creates a different (e.g., progressively more highly processed) set of information relating to the original, raw input (e.g., producing a different representation of the raw input at each layer). Weights are applied to the output of each node of each layer before the output is propagated to the next layer. The weight values are adjusted so that the outputs of some nodes or layers influences the final output more or less than the outputs of other nodes or layers, in some examples. The output layer of the neural network produces the final predictive output, which is made accessible to one or more downstream models, applications, systems, operations, processes or services.

Backpropagation is an example of a method that is often used to train a neural network model. In a feedforward step, the training data is propagated from the input layer through the internal layers to the final output by computing each successive layer's outputs up to and including the final output. A loss function (or cost function, such as cross-entropy, log loss, or squared error loss, or a logistic function) is used to compute error for the final output, for example, based on a comparison of the difference between the output predicted by the model and the expected or target output to the error computed on a previous iteration. The model weights (or parameters or coefficients) are adjusted to reduce the error, iteratively, until the error falls within an acceptable range or the error stops changing by more than a threshold amount (e.g., the model converges). In backpropagation, these iterative weight adjustments are propagated backward from the output layer through the internal layers. The gradient of the loss function or gradient descent (e.g., stochastic gradient descent) is often used in backpropagation.

In some examples, recommendation systems use deep learning models to generate predictive output and use the predictive output to configure or control one or more downstream operations. In some examples, recommendation systems compute statistical or probabilistic predictions that are used to select, rank, or sort digital content items for presentation to users via electronic devices. Examples of downstream operations that are capable of using the predictive output of deep learning recommendation systems include news feeds, automated product recommendations, and automated connection (e.g., friend, follower, or contact) recommendations for online platforms such as social networks. Other examples include systems that support human decision making, such as systems that use artificial intelligence to generate recommendations for health care, financial services, training, education, and/or other fields or topics. Still other examples include control systems that use artificial intelligence to recommend courses of action to other components of automated systems in operational environments, such as “smart” vehicles, appliances, robots, and other automated devices.

In the example of FIG. 11D, the deep neural network 1134 includes an input layer 1135, one or more hidden layers 1136, and an output layer 1137. The input layer 1135 receives one or more batches of model input 1123 (e.g., input feature sets X). In some examples, the input layer 1135 includes a number of nodes that corresponds to the number of input features in a given input feature set X. The output of the input layer 1135 becomes the input to the one or more hidden layers 1136. The output of the one or more hidden layers 1136 becomes the input to the output layer 1137. The output layer 1137 outputs the final predictive output 1138. In some examples, each of the layers of the deep neural network 1134 is fully connected in the sense that the output of each node of each layer is connected to the input of each node of the next subsequent layer. In other examples, the deep neural network 1134 includes portions that are not fully connected.

The deep neural network 1134 is capable of being configured and implemented as a network service. In some examples, the deep neural network 1134 is configured using a machine learning library and an application programming interface (API), e.g., via an API call such as ML_library.model(p1, p2, . . . pn), where p indicates a parameter or argument of the call, such as a model hyperparameter or an input feature set identifier. Once configured, the deep neural network 1134 and/or its output are hosted on one or more servers and/or data storage devices for accessibility to one or more requesting processes, systems, devices, frameworks, or services.

The input feature set X includes numerical features, categorical features, quantitative values, qualitative values, raw features, compressed representations of raw features (e.g., vector representations or embeddings), natural language, and/or other forms of digital content. Embedding refers to a numerical representation of a set of features, in some examples. An embedding encodes information, e.g., a set of features associated with an entity and/or attribute, relative to an embedding space. Embeddings and embedding spaces are generated by artificial intelligence (AI) models. An embedding is often expressed as a vector, where each dimension of the vector includes a numerical value that is an integer or a real number (e.g., a floating point value). The numerical value assigned to a given dimension of the vector conveys information about the data represented by the embedding, relative to the embedding space, also referred to as a vector space. The embedding space (or vector space) includes all of the possible values of each dimension of the vector. The embedding space is defined by the way in which the AI model used to generate the vector has been trained and configured, including the training data used to train the AI model. In some examples, train as used herein refers to an iterative process of applying an AI algorithm to one or more sets of training data, analyzing the output of the AI model in comparison to expected model output using a loss function (also referred to as a cost function or error function), adjusting values of one or more parameters and/or coefficients of the AI model, and repeating the process until the difference between the actual model output and the expected model output falls within an acceptable range of error or tolerance.

Embedding-based retrieval (EBR) is a method of searching for similar digital content, such as documents or portions of documents. Embedding-based retrieval involves converting digital data, e.g., sets of features, to embeddings and then using a similarity algorithm, such as nearest-neighbor search or cosine similarity, to identify embeddings that are similar to one another. Match or map refers to an exact match or an inexact match, in various examples. Match or map refers to a machine-determined predicted or estimated degree of relevance, similarity or compatibility between entities or data items that satisfies (e.g., meets or exceeds) a threshold level of relevance, similarity or compatibility, where the threshold level of relevance, similarity or compatibility is variable based on the requirements of a particular design or implementation. The threshold level of relevance, similarity, or compatibility is set lower or higher for different types of matching or mapping, in some examples.

In response to an instance of feature set X, deep neural network 1134 computes and outputs a predictive output 1138. The predictive output 1138 is stored in a data storage for subsequent lookup or provided to one or more downstream systems, processes, devices, frameworks, and/or services.

The deep neural network 1134 is configured and implemented as a network service, in some examples. The deep neural network 1134 is configured using a machine learning library and an application programming interface (API), e.g., via an API call such as ML_library.model(p1, p2, . . . pn), where p indicates a parameter or argument of the call, such as a model hyperparameter or an input feature set identifier, in some examples. Once configured, the machine learning model 1106 and/or its output are hosted on one or more servers and/or data storage devices for accessibility to one or more requesting processes, systems, devices, frameworks, or services.

The examples shown in FIG. 11D and the accompanying description, above are provided for illustration purposes. This disclosure is not limited to the described examples.

FIG. 11E is a block diagram of a machine learning model that is capable of being used by and/or included in an application software system or instance manager system in accordance with some examples of the present disclosure.

A specific example of a deep neural network is a sequence to sequence model, which takes sequential data such as words, phrases, or images (sequences of characters, tokens, or pixel values) or time series data as input and outputs sequential data. An example of a sequence to sequence model is an encoder-decoder model. In an encoder-decoder model, a first neural network known as an encoder transforms the model input into an encoded version of the model input, e.g., an embedding or vector. In some examples, an encoder transforms a sentence or an image into a sequence of numbers. A second neural network known as the decoder takes the output of the encoder (e.g., the encoded version of the model input) and decodes it. In some examples, a decoder transforms the sequence of numbers created and output by the encoder into a translated sentence or another form of output.

A specific example of an encode-decoder model is a transformer model. A transformer model is a deep neural network encoder-decoder model that uses a technique called attention or self-attention to detect relationships and dependencies among data elements in a sequence. Transformer models are capable of being used to perform various natural language processing (NLP) tasks and other machine learning tasks, such as generating content based on input attributes or tokens. In some examples, the attention mechanism facilitates the detection of relationships and dependencies between words and phrases.

In the example of FIG. 11E, a machine learning system 1140 includes a transformer model 1142. The transformer model 1142 is constructed using a neural network-based machine learning model architecture. In some examples, the neural network-based architecture includes one or more self-attention layers (e.g., multi-head attention layer 1145, masked multi-head attention layer 1155, and multi-head attention layer 1157) that allow the model to assign different weights to different features included in the model input. Alternatively, or in addition, the neural network architecture includes feed-forward layers (e.g., feed-forward layer 1147 and feed-forward layer 1159) and residual connections (e.g., add & norm layer 1146, add & norm layer 1148, add & norm layer 1156, add & norm layer 1158, add & norm layer 1160) that allow the model to machine-learn complex data patterns including relationships between different states, actions, and rewards in multiple different contexts. In some examples, transformer model 1142 is constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation of the user trajectory processing system.

As shown in FIG. 11E, transformer model 1142 feeds embedded subsequences 1150 into encoder 1144 and decoder 1154. For example, transformer model 1142 feeds inputs of embedded subsequences 1150 into multi-head attention layer 1145 of encoder 1144. In some examples, inputs of embedded subsequences 1150 are a series of tokens and the output of the encoder (e.g., encoder output representation 1152), is a fixed-dimensional representation for each of the tokens of embedded subsequences 1150 including an embedding for inputs of embedded subsequences 1150. Transformer model 1142 feeds encoder output representation 1152 and outputs of embedded subsequences 1150 into decoder 1154 which generates a sequence of tokens based on encoder output representation 1152 and the input embeddings. While a specific architecture of encoder 1144 and decoder 1154 is shown for simplicity, as explained above, the exact number and arrangement of layers of each type as well as the hyperparameter values used to configure the model are determined based on the requirements of a particular design or implementation. Therefore, in some examples, transformer model 1142 includes different numbers, arrangements, and types of layers, such that each input token of embedded subsequences 1150 is fed through the layers of transformer model 1142 and is dependent on other input tokens of embedded subsequences 1150.

Transformer model 1142 illustrates a generic encoder/decoder model for simplicity. In such a model, encoder 1144 encodes the input into a fixed-length vector (e.g., encoder output representation 1152) and decoder 1154 decodes the fixed-length vector into an output sequence. Encoder 1144 and decoder 1154 are trained together to maximize the conditional log-likelihood of the output given the input. Once trained, encoder 1144 and decoder 1154 are capable of generating output given an input sequence or scoring a pair of input-output sequences based on their probability of coexistence.

As shown in FIG. 11E, encoder 1144 includes multi-head attention layer 1145, add & norm layer 1146, feed-forward layer 1147, and add & norm layer 1148. Multi-head attention layer 1145 receives inputs of embedded subsequences 1150 and computes output representations for each of the input tokens of embedded subsequences 1150 based on the inputs of embedded subsequences 1150. For example, multi-head attention layer 1145 converts each input token of embedded subsequences 1150 into queries, keys, and values using query, key, and value matrices. Multi-head attention layer 1145 computes the output representation of the input tokens of embedded subsequences 1150 as the weighted sum of the values of all of the input tokens of embedded subsequences 1150. Multi-head attention layer 1145 computes the weights for the weighted sum by applying a compatibility function to the corresponding key and query for the value. For example, multi-head attention layer 1145 uses a scaled dot product on the key and query of an input token to determine a weight to apply to a value of the input token. Multi-head attention layer 1145 includes multiple attention blocks which each compute an output representation for the input token. Multi-head attention layer 1145 aggregates the output representations of these attention blocks to generate a final output representation for multi-head attention layer 1145.

Transformer model 1142 feeds the output representation generated by multi-head attention layer 1145 and residual connections from the inputs of embedded subsequences 1150 into add & norm layer 1146. By including these residual connections, transformer model 1142 ensures that it does not “forget” features of embedded subsequences 1150 during training. Forgetting in the context of machine learning refers to a phenomenon that occurs as the model continues to be sequentially trained on different datasets over time. Because the model continually adjusts the values of feature coefficients as it is trained on subsequent training datasets, these continuous adjustments of the feature coefficient values is capable of causing the influence of the datasets used earlier in training on those coefficient values to be lost or diluted.

Add & norm layer 1146 sums the output representation generated by multi-head attention layer 1145 and the residual connections from inputs of embedded subsequences 1150 and applies a layer normalization to the result. In some examples, the add & normal layers also apply a SoftMax function to generate action probabilities for the inputs of embedded subsequences 1150. For example, add & norm layer 1146 generates estimated probabilities \hat{p}(aₖ|s), where aₖ is the action policy and s is the state features.

Transformer model 1142 feeds the normalized output of add & norm layer 1146 into feed-forward layer 1147. Feed-forward layer 1147 is a feed-forward network that receives the normalized output, feeds it through the hidden layers of feed-forward layer 1147, and then feeds the output of feed-forward layer 1147 into add & norm layer 1148. Feed-forward layer 1147 processes the information received from add & norm layer 1146 and updates the hidden layers of feed-forward layer 1147 based on the information (e.g., during training) and/or generate an output based on the hidden layers processing the information (e.g., during evaluation and/or inference). For example, during training, transformer model 1142 updates the weights of the hidden layers of feed-forward layer 1147 based on the inputs and the loss of the transformer system. Further details with regard to the loss of the transformer system as well as training objectives and metrics are discussed below. As an alternative example, during evaluation and/or inference, the weights of the hidden layers of feed-forward layer 1147 are used to determine the output representation 1152 of each of the input tokens of embedded subsequences 1150.

Transformer model 1142 feeds the output of feed-forward layer 1147 into add & norm layer 1148 as well as residual connections from the output of add & norm layer 1146. Add & norm layer 1148 sums the output of feed-forward layer 1147 with the residual connections from add & norm layer 1146 and applies a layer normalization to the result to generate encoder output representation 1152. Transformer model 1142 feeds encoder output representation 1152 into multi-head attention layer 1157 of decoder 1154 as explained below.

Masked multi-head attention layer 1155 receives outputs of embedded subsequences 1150 and computes representations for each of the output tokens of embedded subsequences 1150 based on masked outputs of embedded subsequences 1150. For example, masked multi-head attention layer 1155 computes representations for each of the output tokens of embedded subsequences 1150 based on previous output tokens while masking future output tokens. Masked multi-head attention layer 1155 therefore only computes representations using tokens that come before the token masked multi-head attention layer 1155 is trying to predict.

Transformer model 1142 feeds the representation generated by masked multi-head attention layer 1155 and residual connections from the outputs of embedded subsequences 1150 into add & norm layer 1156. Add & norm layer 1156 sums the representation generated by masked multi-head attention layer 1155 and the residual connections from outputs of embedded subsequences 1150 and applies a layer normalization to the result.

Transformer model 1142 feeds the normalized output of add & norm layer 1156 into multi-head attention layer 1157. Multi-head attention layer 1157 receives the normalized output of add & norm layer 1156 as well as encoder output representation 1152 from encoder 1144 and generates a representation based on both.

Transformer model 1142 feeds the representation generated by multi-head attention layer 1157 and residual connections from the output of add & norm layer 1156 into add & norm layer 1158. Add & norm layer 1158 sums the representation generated by multi-head attention layer 1157 and the residual connections from the output of add & norm layer 1156 and applies a layer normalization to the result.

Transformer model 1142 feeds the normalized output of add & norm layer 1158 into feed-forward layer 1159. Feed-forward layer 1159 is a feed-forward network that receives the normalized output, feeds it through the hidden layers of feed-forward layer 1159, and then feeds the output of feed-forward layer 1159 into add & norm layer 1169. Feed-forward layer 1159 processes the information received from add & norm layer 1158 and updates the hidden layers of feed-forward layer 1159 based on the information (e.g., during training) and/or generate an output based on the hidden layers processing the information (e.g., during evaluation and/or inference). For example, during training, transformer model 1142 updates the weights of the hidden layers of feed-forward layer 1159 based on the inputs and the loss of the transformer system. Further details with regard to the loss of the transformer system as well as training objectives and metrics are discussed below. As an alternative example, during evaluation and/or inference, the weights of the hidden layers of feed-forward layer 1159 are used to determine the output of feed-forward layer 1159.

Transformer model 1142 feeds the output of feed-forward layer 1159 into add & norm layer 1160 as well as residual connections from the output of add & norm layer 1158. Add & norm layer 1160 sums the output of feed-forward layer 1159 with the residual connections from add & norm layer 1158 and applies a layer normalization to the result to generate an output.

Transformer model 1142 generates output probabilities 1162 from the output of add & norm layer 1160. For example, transformer model 1142 applies a linear transformation and a SoftMax function to the output of add & norm layer 1160 to generate a normalized vector of output probabilities 1162.

In some examples, such as during training, transformer model 1142 determines a loss for the system based on output probabilities 1162. In some examples, transformer model 1142 uses deep quantile regression for training. In such an example, output probabilities 1162 includes a mean prediction probability and estimations for the upper and lower bounds of the range of prediction such that output probabilities 626 includes an uncertainty range. In one example, the loss function of transformer model 1142 using deep quantile regression is represented by the following equation:

$$ℒ ( {ξ}_{i} \vert α ) = \{ \begin{matrix}{αξ}_{i} & if {ξ}_{i} \geq 0 \\ ( α - 1 ) {ξ}_{i} & if {ξ}_{i} < 0\end{matrix} ,$$

where α is the required quantile (a value between 0 and 1 representing the desired quantile) and ξᵢ=yᵢ−f(xᵢ), where f(xᵢ) is the mean predicted by output probabilities 1162, yᵢ are the outputs of embedded subsequences 1150 and xᵢ are the inputs of embedded subsequences 1150. The loss over the entirety of a dataset of embedded subsequences 1150 where embedded subsequences 1150 has a length of N is capable of being represented by the following equation:

$$ℒ ( y , f \vert α ) = \frac{1}{N} {\sum }_{i = 1}^{N} ℒ ( {y}_{i} - f ( {x}_{i} ) \vert α ) .$$

In such examples, output probabilities 1162 includes three values: a mean prediction, a lower bound quantile, and an upper bound quantile. In some examples, transformer model 1142 uses upper confidence bound or Thompson sampling. In some examples, transformer model 1142 determines model output 1164 based on the mean prediction, the lower bound quantile, and the upper bound quantile based on upper confidence bound and/or Thompson sampling.

In some examples, transformer model 1142 is trained to optimize the model parameters with trajectory-specific normalizations using cross-entropy loss. For example, transformer model 1142 uses a loss function represented by the following equation:

$$L ( θ ) = \frac{1}{{N}_{traj}} {\sum }_{i}^{{N}_{traj}} {\sum }_{f = 1}^{{T}_{i}} {w}_{i} {\sum }_{k} log ( \hat{p} ( {a}_{k}^{( it )} \vert {s}^{( it )} ) ) ,$$

where Nₜᵣₐⱼ is the trajectory count, wᵢ is the normalization weight, aₖ^{(it)} is the predicted action for the trajectory i at timestep t, and s^{(it)} is the state of the online system for the trajectory i at timestep t. In some examples, transformer model 1142 uses trajectory-wise normalization. In some examples, the add & norm layers of transformer model 1142 normalize the weights according to the following equation:

$${w}_{i} = \frac{1}{{T}_{i}} ,$$

where Tᵢ is the length of trajectory i. In some examples, transformer model 1142 uses global normalization. In some examples, the add & norm layers of transformer model 1142 normalize the weights according to the following equation: wᵢ=c, where c is a positive scalar. In some examples, the scalar c is predetermined.

Language models, including large language models and other generative models, are capable of being implemented using transformer models. A generative model is commonly constructed using a neural network-based machine learning model architecture. In some examples, the neural network-based architecture includes one or more input layers that receive task descriptions (or prompts), generate one or more embeddings based on the task descriptions, and pass the one or more embeddings to one or more other layers of the neural network. In other examples, the one or more embedding are generated based on the task description by a pre-processor, the embeddings are input to the generative language model, and the generative language model outputs digital content, e.g., natural language text or a combination of natural language text and non-text output, based on the embeddings.

The neural network-based machine learning model architecture of the generative model often includes one or more self-attention layers that allow the model to assign different weights to different portions of the model input (e.g., different words or phrases included in the model input). Alternatively or in addition, the neural network architecture includes feed-forward layers and residual connections that allow the model to machine-learn complex data patterns including relationships between different words or phrases in multiple different contexts. The language model or other type of generative model is capable of being constructed using a transformer-based architecture that includes self-attention layers, feed-forward layers, and residual connections between the layers. The exact number and arrangement of layers of each type as well as the hyperparameter values used to configure the model are determined based on the requirements of a particular design or implementation.

In some examples, the neural network-based machine learning model architecture of a generative model includes or is based on one or more generative transformer models, one or more generative pre-trained transformer (GPT) models, one or more bidirectional encoder representations from transformers (BERT) models, one or more large language models (LLMs), one or more XLNet models, and/or one or more other natural language processing (NL) models that significantly advance the state-of-the-art in various linguistic tasks such as machine translation, sentiment analysis, question answering and sentence similarity. In some examples, the neural network-based machine learning model architecture includes or is based on one or more predictive content neural models that receive digital content input and generate one or more outputs based on processing the digital content with one or more neural network models. Examples of predictive neural models include, but are not limited to, Generative Pre-Trained Transformers (GPT), BERT, and/or Recurrent Neural Networks (RNNs). In some examples, one or more types of neural network-based machine learning model architecture includes or is based on one or more multimodal neural networks capable of outputting different modalities (e.g., text, image, sound, etc.) separately and/or in combination based on digital content input. Accordingly, in some examples, a multimodal neural network is capable of outputting digital content that includes a combination of two or more of text, images, video or sound.

A generative language model is capable of being trained on a large dataset of natural language text. In some examples, training samples of natural language text extracted from publicly available data sources are used to train a generative language model. The size and composition of the dataset used to train the generative language model are variable according to the requirements of a particular design or implementation. In some examples, the dataset used to train the generative language model includes hundreds of thousands to millions or more different natural language text training samples. In some examples, a generative language model includes multiple generative language models trained on differently sized datasets. In some examples, a generative language model includes a comprehensive but low capacity model that is trained on a large data set and used for generating examples. The same generative language model also includes a less comprehensive but high capacity model that is trained on a smaller data set, such that the high capacity model is used to generate outputs based on data obtained from the low capacity model. In some examples, reinforcement learning is used to further improve the output of the generative language model. In reinforcement learning, ground-truth examples of desired model output are paired with respective prompts, and these prompt-output pairs are used to train or fine tune the generative language model.

Prompt engineering is a technique used to optimize the structure and/or content of a prompt input to a generative model. Some prompts include examples of outputs to be generated by the generative model (e.g., few-shot prompts), while other prompts include no examples of outputs to be generated by the generative model (e.g., zero-shot prompts). Chain of thought prompting is a prompt engineering technique where the prompt includes a request that the model explain reasoning in the output. For example, the generative model performs the task described in the prompt using a series of steps and outputs reasoning as to each step performed.

Supervised learning is a method of training (or fine-tuning) a machine learning model given input-output pairs, where the output of the input-output pair is known (e.g., an expected output, a labeled output, a ground truth). Other training methods including semi-supervised learning or federated learning are capable of being used to train a machine learning model or to fine-tune a pretrained machine learning model.

The transformer model 1142 is configured and implemented as a network service, in some examples. The transformer model 1142 is configured using a machine learning library and an application programming interface (API), e.g., via an API call such as ML_library.model(p1, p2, . . . pn), where p indicates a parameter or argument of the call, such as a model hyperparameter or an input identifier. Once configured, the transformer model 1142 and/or its output are hosted on one or more servers and/or data storage devices for accessibility to one or more requesting processes, systems, devices, frameworks, or services.

The examples shown in FIG. 11E and the accompanying description, above are provided for illustration purposes. This disclosure is not limited to the described examples.

FIG. 12 is an example of an entity graph in accordance with some embodiments of the present disclosure. An entity graph includes nodes, edges, and data (such as attribute types, attributes, labels, weights, or scores) associated with nodes and/or edges. In some examples, nodes are weighted based on edge counts, and edges are weighted based on commonalities between the nodes connected by the edges, such as common attribute values (e.g., two users have the same job title or employer).

A graphing mechanism is used to create, update and maintain the entity graph. In some implementations, the graphing mechanism is a component of the database architecture used to implement the entity graph 1200. In some examples, the graphing mechanism is a component of data stores 142 and/or application software system 122, described with reference to FIG. 1, and the entity graphs created by the graphing mechanism are stored in one or more of the data stores 142.

In the example of FIG. 12, entity graph 1200 includes nodes 1202, 1204, 1206, 1208, 1210, 1212, 1214, 1216, 1218, and 1244. As indicated in the legend, the nodes 1202, 1204, 1206, 1208, 1210, 1212, 1214, 1216, 1218, and 1244 represent various entities of different entity types. In the example of FIG. 12, nodes 1202, 1204, 1206, and 1208 represent entities of a first entity type (e.g., users of an online system, agents, organizations, etc.); node 1216 represents an entity of a second entity type (e.g., a user attribute, such as a skill set, nodes 1210 and 1212 represent entities of a third entity type (e.g., an attribute of a content item); nodes 1214 and 1244 represent entities of a fourth entity type (e.g., a network activity attribute, such as a usage channel or interaction statistics), and node 1218 represents an entity of a fifth entity type (e.g., a content item, such as a document or job posting).

Entity graph 1200 also includes edges 1220, 1222, 1224, 1226, 1228, 1230, 1232, 1234, 1236, 1238, 1240, 1242, 1246. The edges 1220, 1222, 1224, 1226, 1228, 1230, 1232, 1234, 1236, 1238, 1240, 1242, 1246 individually and/or collectively represent various different types of relationships between or among the nodes 1202, 1204, 1206, 1208, 1210, 1212, 1214, 1216, 1218, and 1244. In some examples, data is linked with both nodes and edges. In some examples, when stored in a data store, each node is assigned a unique node identifier and each edge is assigned a unique edge identifier. The edge identifier includes a combination of the node identifiers of the nodes connected by the edge and a timestamp that indicates the date and time at which the edge was created, in some examples. In the example graph 1200, some of the edges between user nodes, such as edges 1220, 1222, 1236, represent online relationships between the users represented by the nodes, such as ‘friend’ or ‘follower’ connections between the connected nodes. In the example graph 1200, user node 1204 is a first-degree connection of user node 1202 and user node 1206, while user node 1206 is a second-degree connection of user node 1202, and user node 1208 is a first degree connection of user node 1202 but user node 1208 is not connected with either of user node 1204 or user node 1206.

Alternatively or in addition, in the example entity graph 1200, edges represent measures of similarity or affinity between the nodes connected by the edges. In some examples, user node 1202 is connected to skill set node 1216 by edge 1224 because the user associated with the user node 1202 has the skill set represented by the skill set node 1216 listed in a “skills” section of the user's profile page in an online system (e.g., application software system 122). In some examples, user node 1206 is connected to skill set node 1216 by edge 1240 because the user associated with the user node 1206 has a job title that matches the skill set represented by the skill set node 1216 listed in the user's profile page.

The example entity graph 1200 includes attribute entities that are associated with other, different entity types. In the illustrated example, the skill set attribute is an attribute of the user entity type while the topic attribute is an attribute of a document entity type. Thus, whereas the skill set node 1216 is linked with the user node 1202 by edge 1224 and with the user node 1206 by edge 1240, there are no first-degree links between user nodes and topic nodes 1210, 1212, 1214. Similarly, whereas a document node 1218 is linked with topic nodes 1212, 1210, and 1214 by edges 1242, 1232, 1230, respectively, there are no first-degree links between the document node 1218 and the skill set node 1216.

Edges are capable of being created between topic nodes and skill set nodes. For example, edge 1234 can represent a first measure of similarity between the skill set node 1216 and the topic node 1210, and the combination of edges 1234 and 1232 can represent a measure of similarity between the skill set node 1216 and the topic node 1216.

Additionally or alternatively, in the example entity graph 1200, edges represent measures of activity involving the nodes connected by the edges. In some examples, edge 1246 is created between user node 1202 and channel node 1244 because the user represented by user node 1202 used the channel represented by channel node 1214 (i.e., a particular mobile version of an online system on a mobile device) to log in to the online system and scroll through the user's feed on a mobile device. In some examples, edge 1228 is created between user node 1202 and channel node 1214 because the user represented by user node 1202 logged into a web version of the online system on a laptop and uploaded and shared a document represented by document node 1218 using the channel (i.e., laptop, web version of application) represented by the channel node 1214.

In some examples, combinations of nodes and edges are used to compute various scores, and those scores are used by various components of the instance manager 108 and/or application software system 122 to, for example, generate prompts, match content items with users, etc. In some examples, a score that measures the affinity of the user represented by user node 1202 to the topic represented by topic node 1212 is computed using a path p1 that includes a sequence of edges 1224, 1234, 1232 and/or a path p2 that includes a sequence of edges 1228, 1230, 1240 and/or a path p3 that includes a sequence of edges 1238, 1242. In some examples, the paths p2 and/or p3 are used to compute a score that represents an affinity between the user represented by the user node 1202 and the channel represented by channel node 1214.

Additionally or alternatively, edges between user nodes and content item nodes can be created and added to entity graph 1200 to represent online interactions between users and content items, such as job postings and documents. In some examples, edge 1238 indicates that the user associated with the user node 1202 created the document represented by document node 1218, and edge 1226 indicates that the user associated with the user node 1208 viewed or liked the document represented by the document node 1218. Based on user-document edges such as edges 1226 and 1238, a ranking score can be computed for a document represented by document node 1218, e.g., based on edge count. In some implementations, a document having a higher edge count than other documents represented in the entity graph 1200 is selected, instead of those other documents, for one or more downstream actions of the instance manager 108 and/or application software system 122, such as prompt generation or entity matching.

In some examples, a graph database such as described with reference to FIG. 12 is used to store verified profile data for entities that have a verified relationship with the group associated with the first or verified instance of an application software system. In those examples, unverified profile data obtained from the second instance of the software application is capable of being used to supplement the verified profile data in the first instance, e.g., to supplement the group-specific profile data stored in the first instance for the entities having verified relationships with the group identifier.

The examples shown in FIG. 12 and the accompanying description, above are provided for illustration purposes. This disclosure is not limited to the described examples.

FIG. 13 is a block diagram of an example computer system including components of an application software system or instance manager system in accordance with some examples of the present disclosure.

In FIG. 13, an example machine of a computer system 1300 is shown, within which a set of instructions for causing the machine to perform any of the methodologies discussed herein are capable of being executed. In some examples, the computer system 1300 corresponds to a component of a networked computer system (e.g., any one or more of the components shown in FIG. 1, FIG. 2, FIG. 3, FIG. 4, FIG. 5, FIG. 6, FIG. 9, FIG. 10, FIG. 11A-11E, or FIG. 12) that includes, is coupled to, or utilizes a machine to execute an operating system to perform operations corresponding to any one or more components shown in FIG. 1, FIG. 2, FIG. 3, FIG. 4, FIG. 5, FIG. 6, FIG. 9, FIG. 10, FIG. 11A-11E, or FIG. 12. For example, computer system 1300 corresponds to a portion of a computing system when the computing system is executing a portion of any one or more components shown in FIG. 1, FIG. 2, FIG. 3, FIG. 4, FIG. 5, FIG. 6, FIG. 9, FIG. 10, FIG. 11A-11E, or FIG. 12.

The machine is connected (e.g., networked) to other machines in a network, such as a local area network (LAN), an intranet, an extranet, and/or the Internet. The machine operates in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 1300 includes a processing device 1302, a main memory 1304 (e.g., read-only memory (ROM), flash memory, dynamic random access memory (DRAM) such as synchronous DRAM (SDRAM) or Rambus DRAM (RDRAM), etc.), a memory 1303 (e.g., flash memory, static random access memory (SRAM), etc.), an input/output system 1310, and a data storage system 1340, which communicate with each other via a bus 1330.

Processing device 1302 represents one or more general-purpose processing devices such as a microprocessor, a central processing unit, or the like. In some examples, the processing device is a complex instruction set computing (CISC) microprocessor, reduced instruction set computing (RISC) microprocessor, very long instruction word (VLIW) microprocessor, or a processor implementing other instruction sets, or processors implementing a combination of instruction sets. In some examples, processing device 1302 includes a special-purpose processing device such as an application specific integrated circuit (ASIC), a field programmable gate array (FPGA), a digital signal processor (DSP), network processor, or the like. The processing device 1302 is to execute instructions 1312 for performing the operations and steps discussed herein.

In some examples of FIG. 13, instance manager system 1350 represents portions of instance manager system 1080 while the computer system 1300 is executing those portions of instance manager system 1080. Instructions 1312 include portions of instance manager system 1350 when those portions of the instance manager system 1350 are being executed by processing device 1302. Thus, the instance manager system 1350 is shown in dashed lines as part of instructions 1312 to illustrate that, at times, portions of the instance manager system 1350 are executed by processing device 1302. For example, when at least some portion of the instance manager system 1350 is embodied in instructions to cause processing device 1302 to perform the method(s) described herein, some of those instructions are read into processing device 1302 (e.g., into an internal cache or other memory) from main memory 1304 and/or data storage system 1340. In some examples, it is not required that all of the instance manager system 1350 be included in instructions 1312 at the same time and portions of the instance manager system 1350 are stored in another component of computer system 1300 at other times, e.g., when a portion of the instance manager system 1350 is not being executed by processing device 1302.

The computer system 1300 further includes a network interface device 1308 to communicate over the network 1320. Network interface device 1308 provides a two-way data communication coupling to a network. In some examples, network interface device 1308 includes an integrated-services digital network (ISDN) card, cable modem, satellite modem, or a modem to provide a data communication connection to a corresponding type of telephone line. In some examples, network interface device 1308 includes a local area network (LAN) card to provide a data communication connection to a compatible LAN. Wireless links are included, in some examples. Network interface device 1308 sends and receives electrical, electromagnetic, or optical signals that carry digital data representing various types of information.

The network link is capable of providing data communication through one or more networks to other data devices. In some examples, a network link provides a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 1300.

Computer system 1300 is capable of sending messages and receiving data, including program code, through the network(s) and network interface device 1308. In some examples, a server is capable of transmitting a requested code for an application program through the Internet and network interface device 1308. The received code is executed by processing device 1302 as it is received, and/or stored in data storage system 1340 or other non-volatile storage for later execution.

The input/output system 1310 includes an output device, such as a display, for example a liquid crystal display (LCD) or a touchscreen display, for displaying information to a computer user, or a speaker, a haptic device, or another form of output device. The input/output system 1310 includes an input device, for example, alphanumeric keys and other keys configured for communicating information and command selections to processing device 1302. An input device sometimes includes a cursor control, such as a mouse, a trackball, or cursor direction keys for communicating direction information and command selections to processing device 1302 and for controlling cursor movement on a display. An input device sometimes includes a microphone, a sensor, or an array of sensors, for communicating sensed information to processing device 1302. Examples of sensed information include voice commands, audio signals, geographic location information, haptic information, and/or digital imagery, for example.

The data storage system 1340 includes a machine-readable storage medium 1342 (also known as a computer-readable medium) on which is stored instructions 1344 or software embodying any of the methodologies or functions described herein. The instructions 1344 sometimes reside, completely or at least partially, within the main memory 1304 and/or within the processing device 1302 during execution thereof by the computer system 1300, the main memory 1304 and the processing device 1302 also constituting machine-readable storage media. In one example, the instructions 1344 include instructions to implement functionality corresponding to an application software system and/or instance manager system (e.g., any one or more of the components shown in any one or more components shown in FIG. 1, FIG. 2, FIG. 3, FIG. 4, FIG. 5, FIG. 6, FIG. 7, FIG. 8, FIG. 9, FIG. 10, or FIG. 11A-11E.

Dashed lines are used in FIG. 13 to indicate that it is not required that the instance manager system be embodied entirely in instructions 1312, 1314, and 1344 at the same time. In one example, portions of the instance manager system are embodied in instructions 1314, which are read into main memory 1304 as instructions 1314, and portions of instructions 1312 are read into processing device 1302 as instructions 1312 for execution. In another example, some portions of the instance manager system are embodied in instructions 1344 while other portions are embodied in instructions 1314 and still other portions are embodied in instructions 1312.

While the machine-readable storage medium 1342 is shown in an example to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media.

The examples shown in FIG. 13 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure refers to actions and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations described herein. This apparatus is specially constructed for the intended purposes, in some examples. In other examples, the apparatus includes a general-purpose computer selectively activated or reconfigured by a computer program stored in the computer. In some examples, a computer system or other data processing system including any one or more of the components shown in FIG. 1, FIG. 2, FIG. 3, FIG. 4, FIG. 5, FIG. 6, FIG. 9, FIG. 10, FIG. 11A-11E, FIG. 12 and/or FIG. 13, carries out the above-described computer-implemented methods in response to its processor executing a computer program (e.g., a sequence of instructions) contained in a memory or other non-transitory machine-readable storage medium. Such a computer program is be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems are capable of being used. A more specialized apparatus is constructed, in some examples. Examples of structure for these systems are provided in the description. Aspects of this disclosure are not limited to any particular programming language. A variety of programming languages are usable to implement the various aspects of this disclosure.

Some examples of the present disclosure are provided as a computer program product, or software, which includes a machine-readable medium having stored thereon instructions, which is used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein are capable of being implemented with privacy safeguards to protect user privacy. Furthermore, the techniques described herein are capable of being implemented with user privacy safeguards to prevent unauthorized access to personal data and confidential data. The training of the AI models described herein is executed to benefit all users fairly, without causing or amplifying unfair bias.

According to some examples, the techniques for the models described herein do not make inferences or predictions about individuals unless requested to do so through an input. According to some examples, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users are capable of having full control over the visibility of their content and who sees their content, as is controlled via the visibility settings. According to the techniques described herein, users are capable of having full control over the level of their personal data that is shared and distributed between different AI platforms that provide different functionalities.

According to the techniques described herein, users are capable of choosing to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users are capable of having full control over the level of access to their personal data that is shared with other parties. According to the techniques described herein, personal data provided by users is capable of being processed to determine prompts when using a generative AI feature at the request of the user, but not to train generative AI models. In some examples, users are capable of providing feedback while using the techniques described herein, which is capable of being used to improve or modify the platform and products. In some examples, any personal data associated with a user, such as personal information provided by the user to the platform, is deleted from storage upon user request. In some examples, personal information associated with a user is permanently deleted from storage when a user deletes their account from the platform.

According to the techniques described herein, personal data is capable of being removed from any training dataset that is used to train AI models. In some examples, the techniques described herein utilize tools for anonymizing member and customer data. A user's personal data is capable of being redacted and minimized in training datasets for training AI models through delexicalization tools and other privacy enhancing tools for safeguarding user data. The techniques described herein are capable of minimizing use of any personal data in training AI models, including removing and replacing personal data. In examples of the techniques described herein, notices are communicated to users to inform how their data is being used and users are provided controls to opt-out from their data being used for training AI models.

According to some examples, tools are used with the techniques described herein to identify and mitigate risks associated with AI in all products and AI systems. In some examples, notices are provided to users when AI tools are being used to provide features.

Illustrative examples of the technologies disclosed herein are provided below. An example of the technologies includes any of the examples described herein, or any combination of any of the examples described herein, or any combination of any portions of the examples described herein.

In some aspects, the techniques described herein relate to a method including: verifying a relationship between an entity and a first group identifier; establishing a first instance of a software application at a device, wherein use of the first instance is restricted to the entity having the verified relationship with the first group identifier; via the first instance, storing verified profile data for the entity, wherein access to the stored verified profile data is restricted to one or more entities that have a verified relationship with the first group identifier; and providing unverified profile data to the first instance, wherein the unverified profile data is obtained from a second instance of the software application, and wherein the first instance is to use the verified profile data and the unverified profile data to cause a content delivery event for the entity at the device via the first instance.

In some aspects, the techniques described herein relate to a method, wherein the verified profile data includes first attribute data and the unverified profile data includes second attribute data different from the first attribute data.

In some aspects, the techniques described herein relate to a method, wherein the verified profile data includes a first type of attribute data and the unverified profile data includes a second type of attribute data different from the first type of attribute data.

In some aspects, the techniques described herein relate to a method, wherein the verified profile data includes first interaction data limited to interactions of the entity with other entities associated with the first group identifier and the unverified profile data includes second interaction data different from the first interaction data.

In some aspects, the techniques described herein relate to a method, wherein the verified profile data is inaccessible to the second instance of the software application.

In some aspects, the techniques described herein relate to a method, wherein the first instance of the software application includes a first sub-application and a second sub-application, and the method includes: generating the verified profile data via the first sub-application; and using the verified profile data generated via the first sub-application to generate the content delivery event, wherein the content delivery event is generated via the second sub-application.

In some aspects, the techniques described herein relate to a method, wherein the first sub-application includes one of a search engine, a recommendation engine, an online learning platform, a connections network, a messaging system, a notification center, or a digital content feed, and the second sub-application is different from the first sub-application.

In some aspects, the techniques described herein relate to a method, further including: using a machine learning model to generate the content delivery event for the entity, wherein the machine learning model is trained using data specific to the first group identifier.

In some aspects, the techniques described herein relate to a method, further including: receiving an input via the first instance; and using the input, switching the entity from use of the first instance of the software application via a first entity identifier associated with the first group identifier to use of the second instance of the software application via a second entity identifier, wherein the first instance is inaccessible via the second entity identifier.

In some aspects, the techniques described herein relate to a method, wherein executing the content delivery event includes filtering digital content using a criterion associated with the first group identifier.

In some aspects, the techniques described herein relate to a method, wherein the first group identifier is inaccessible to the second instance.

In some aspects, the techniques described herein relate to a method, wherein the unverified profile data is associated with the second instance, the entity, and a second group identifier different from the first group identifier.

In some aspects, the techniques described herein relate to a method, wherein data of the unverified profile data is used to supplement a graph database for the verified profile data.

In some aspects, the techniques described herein relate to a system including: a processor; and memory operably coupled to the processor, wherein the memory includes instructions that when executed by the processor cause the processor to: verify a relationship between an entity and a first group identifier; establish a first instance of a software application at a device, wherein use of the first instance is restricted to the entity having the verified relationship with the first group identifier; via the first instance, store verified profile data for the entity, wherein access to the stored verified profile data is restricted to one or more entities that have a verified relationship with the first group identifier; and provide unverified profile data to the first instance, wherein the unverified profile data is obtained from a second instance of the software application, and wherein the first instance is to use the verified profile data and the unverified profile data to cause a content delivery event for the entity at the device via the first instance.

In some aspects, the techniques described herein relate to a system, wherein the first group identifier is inaccessible to the second instance.

In some aspects, the techniques described herein relate to a system, wherein the unverified profile data is associated with the second instance, the entity, and a second group identifier different from the first group identifier.

In some aspects, the techniques described herein relate to a system, wherein data of the unverified profile data is used to supplement a graph database for the verified profile data.

In some aspects, the techniques described herein relate to a system, wherein the verified profile data includes first attribute data and the unverified profile data includes second attribute data different from the first attribute data.

In some aspects, the techniques described herein relate to a non-transitory computer readable medium including instructions that when executed by a processor cause the processor to: verify a relationship between an entity and a first group identifier; establish a first instance of a software application at a device, wherein use of the first instance is restricted to the entity having the verified relationship with the first group identifier; via the first instance, store verified profile data for the entity, wherein access to the stored verified profile data is restricted to one or more entities that have a verified relationship with the first group identifier; and provide unverified profile data to the first instance, wherein the unverified profile data is obtained from a second instance of the software application, and wherein the first instance is to use the verified profile data and the unverified profile data to cause a content delivery event for the entity at the device via the first instance.

In some aspects, the techniques described herein relate to a non-transitory computer readable medium, wherein at least one of: the verified profile data includes a first type of attribute data and the unverified profile data includes a second type of attribute data different from the first type of attribute data; or the verified profile data includes first interaction data limited to interactions of the entity with other entities associated with the first group identifier and the unverified profile data includes second interaction data different from the first interaction data; or the verified profile data is inaccessible to the second instance of the software application.
Clause 1. A method comprising: verifying a relationship between an entity and a first group identifier; establishing a first instance of a software application at a device, wherein use of the first instance is restricted to the entity having the verified relationship with the first group identifier; via the first instance, storing verified profile data for the entity, wherein access to the stored verified profile data is restricted to one or more entities that have a verified relationship with the first group identifier; and providing unverified profile data to the first instance, wherein the unverified profile data is obtained from a second instance of the software application, and wherein the first instance is to use the verified profile data and the unverified profile data to cause a content delivery event for the entity at the device via the first instance.
Clause 2. The method of clause 1, wherein the verified profile data comprises first attribute data and the unverified profile data comprises second attribute data different from the first attribute data.
Clause 3. The method of clause 1, wherein the verified profile data comprises a first type of attribute data and the unverified profile data comprises a second type of attribute data different from the first type of attribute data.
Clause 4. The method of clause 1 or clause 2, wherein the verified profile data comprises first interaction data limited to interactions of the entity with other entities associated with the first group identifier and the unverified profile data comprises second interaction data different from the first interaction data.
Clause 5. The method of any of clauses 1-3, wherein the verified profile data is inaccessible to the second instance of the software application.
Clause 6. The method of any of clauses 1-4, wherein the first instance of the software application comprises a first sub-application and a second sub-application, and the method comprises: generating the verified profile data via the first sub-application; and using the verified profile data generated via the first sub-application to generate the content delivery event, wherein the content delivery event is generated via the second sub-application.
Clause 7. The method of clause 6, wherein the first sub-application comprises one of a search engine, a recommendation engine, an online learning platform, a connections network, a messaging system, a notification center, or a digital content feed, and the second sub-application is different from the first sub-application.
Clause 8. The method of any of clauses 1-7, further comprising: using a machine learning model to generate the content delivery event for the entity, wherein the machine learning model is trained using data specific to the first group identifier.
Clause 9. The method of any of clauses 1-8, further comprising: receiving an input via the first instance; and using the input, switching the entity from use of the first instance of the software application via a first entity identifier associated with the first group identifier to use of the second instance of the software application via a second entity identifier, wherein the first instance is inaccessible via the second entity identifier.
Clause 10. The method of any of clauses 1-9, wherein executing the content delivery event comprises filtering digital content using a criterion associated with the first group identifier.
Clause 11. The method of any of clauses 1-10, wherein the first group identifier is inaccessible to the second instance.
Clause 12. The method of any of clauses 1-11, wherein the unverified profile data is associated with the second instance, the entity, and a second group identifier different from the first group identifier.
Clause 13. The method of any of clauses 1-12, wherein data of the unverified profile data is used to supplement a graph database for the verified profile data.
Clause 14. A system comprising: a processor; and memory operably coupled to the processor, wherein the memory comprises instructions that when executed by the processor cause the processor to: verify a relationship between an entity and a first group identifier; establish a first instance of a software application at a device, wherein use of the first instance is restricted to the entity having the verified relationship with the first group identifier; via the first instance, store verified profile data for the entity, wherein access to the stored verified profile data is restricted to one or more entities that have a verified relationship with the first group identifier; and provide unverified profile data to the first instance, wherein the unverified profile data is obtained from a second instance of the software application, and wherein the first instance is to use the verified profile data and the unverified profile data to cause a content delivery event for the entity at the device via the first instance.
Clause 15. The system of clause 14, wherein the first group identifier is inaccessible to the second instance.
Clause 16. The system of clause 14 or clause 15, wherein the unverified profile data is associated with the second instance, the entity, and a second group identifier different from the first group identifier.
Clause 17. The system of any of clauses 14-16, wherein data of the unverified profile data is used to supplement a graph database for the verified profile data.
Clause 18. The system of any of clauses 14-17, wherein the verified profile data comprises first attribute data and the unverified profile data comprises second attribute data different from the first attribute data.
Clause 19. A non-transitory computer readable medium comprising instructions that when executed by a processor cause the processor to: verify a relationship between an entity and a first group identifier; establish a first instance of a software application at a device, wherein use of the first instance is restricted to the entity having the verified relationship with the first group identifier; via the first instance, store verified profile data for the entity, wherein access to the stored verified profile data is restricted to one or more entities that have a verified relationship with the first group identifier; and provide unverified profile data to the first instance, wherein the unverified profile data is obtained from a second instance of the software application, and wherein the first instance is to use the verified profile data and the unverified profile data to cause a content delivery event for the entity at the device via the first instance.
Clause 20. The non-transitory computer readable medium of clause 19, wherein at least one of: the verified profile data comprises a first type of attribute data and the unverified profile data comprises a second type of attribute data different from the first type of attribute data; or the verified profile data comprises first interaction data limited to interactions of the entity with other entities associated with the first group identifier and the unverified profile data comprises second interaction data different from the first interaction data; or the verified profile data is inaccessible to the second instance of the software application.

Aspects of the disclosure have been described with reference to specific examples. Various modifications are capable of being made to the described examples without departing from the spirit and scope of the disclosure reflected in the claims. The specification and drawings are illustrative and not restrictive.

What is claimed is:

1. A method comprising:
verifying a relationship between an entity and a first group identifier;
establishing a first instance of a software application at a device, wherein use of the first instance is restricted to the entity having the verified relationship with the first group identifier;
via the first instance, storing verified profile data for the entity, wherein access to the stored verified profile data is restricted to one or more entities that have a verified relationship with the first group identifier; and
providing unverified profile data to the first instance, wherein the unverified profile data is obtained from use of a second instance of the software application, and wherein the first instance is to use the verified profile data and the unverified profile data to cause a content delivery event for the entity at the device via the first instance.

2. The method of claim 1, wherein the verified profile data comprises first attribute data and the unverified profile data comprises second attribute data different from the first attribute data.

3. The method of claim 1, wherein the verified profile data comprises a first type of attribute data and the unverified profile data comprises a second type of attribute data different from the first type of attribute data.

4. The method of claim 1, wherein the verified profile data comprises first interaction data limited to interactions of the entity with other entities associated with the first group identifier and the unverified profile data comprises second interaction data different from the first interaction data.

5. The method of claim 1, wherein the verified profile data is inaccessible to the second instance of the software application.

6. The method of claim 1, wherein the first instance of the software application comprises a first sub-application and a second sub-application, and the method comprises:
generating the verified profile data via the first sub-application; and
using the verified profile data generated via the first sub-application to generate the content delivery event, wherein the content delivery event is generated via the second sub-application.

7. The method of claim 6, wherein the first sub-application comprises one of a search engine, a recommendation engine, an online learning platform, a connections network, a messaging system, a notification center, or a digital content feed, and the second sub-application is different from the first sub-application.

8. The method of claim 1, further comprising:
using a machine learning model to generate the content delivery event for the entity, wherein the machine learning model is trained using data specific to the first group identifier.

9. The method of claim 1, further comprising:
receiving an input via the first instance; and
using the input, switching the entity from use of the first instance of the software application via a first entity identifier associated with the first group identifier to use of the second instance of the software application via a second entity identifier, wherein the first instance is inaccessible via the second entity identifier.

10. The method of claim 1, wherein executing the content delivery event comprises filtering digital content using a criterion associated with the first group identifier.

11. The method of claim 1, wherein the first group identifier is inaccessible to the second instance.

12. The method of claim 1, wherein the unverified profile data is associated with the second instance, the entity, and a second group identifier different from the first group identifier.

13. The method of claim 1, wherein data of the unverified profile data is used to supplement a graph database for the verified profile data.

14. A system comprising:
a processor; and
memory operably coupled to the processor, wherein the memory comprises instructions that when executed by the processor cause the processor to:
verify a relationship between an entity and a first group identifier;
establish a first instance of a software application at a device, wherein use of the first instance is restricted to the entity having the verified relationship with the first group identifier;
via the first instance, store verified profile data for the entity, wherein access to the stored verified profile data is restricted to one or more entities that have a verified relationship with the first group identifier; and
provide unverified profile data to the first instance, wherein the unverified profile data is obtained from use of a second instance of the software application, and wherein the first instance is to use the verified profile data and the unverified profile data to cause a content delivery event for the entity at the device via the first instance.

15. The system of claim 14, wherein the first group identifier is inaccessible to the second instance.

16. The system of claim 14, wherein the unverified profile data is associated with the second instance, the entity, and a second group identifier different from the first group identifier.

17. The system of claim 14, wherein data of the unverified profile data is used to supplement a graph database for the verified profile data.

18. The system of claim 14, wherein the verified profile data comprises first attribute data and the unverified profile data comprises second attribute data different from the first attribute data.

19. A non-transitory computer readable medium comprising instructions that when executed by a processor cause the processor to:
verify a relationship between an entity and a first group identifier;
establish a first instance of a software application at a device, wherein use of the first instance is restricted to the entity having the verified relationship with the first group identifier;
via the first instance, store verified profile data for the entity, wherein access to the stored verified profile data is restricted to one or more entities that have a verified relationship with the first group identifier; and
provide unverified profile data to the first instance, wherein the unverified profile data is obtained from use of a second instance of the software application, and wherein the first instance is to use the verified profile data and the unverified profile data to cause a content delivery event for the entity at the device via the first instance.

20. The non-transitory computer readable medium of claim 19, wherein at least one of:
the verified profile data comprises a first type of attribute data and the unverified profile data comprises a second type of attribute data different from the first type of attribute data; or
the verified profile data comprises first interaction data limited to interactions of the entity with other entities associated with the first group identifier and the unverified profile data comprises second interaction data different from the first interaction data; or
the verified profile data is inaccessible to the second instance of the software application.
